(19) United States
(12) Patent Application Publication
(10) Pub. No.: US 2012/0228991 A1
(43) Pub. Date: Sep. 13, 2012

(54) Tape muscle

(76) Inventor: John M. VRANISH, Crofton, MD (US)

(21) Appl. No.: 13/385,177

(22) Filed: Feb. 6, 2012

Related U.S. Application Data
(60) Provisional application No. 61/462,714, filed on Feb. 7, 2011.

(51) Int. Cl. H02N 1/00

(52) U.S. Cl. 310/300

(57) ABSTRACT

A Tape Muscle is described where multiple tape loops are independently driven by synchronized grasp and pull actions from a tandem of Clamp, Clamp & Drive modules. Each tape loop is elastically bent, with its open ends threaded through individual passageways in both modules. Tape loops are nested inside each other with all tape open ends on the same side. Each loop moves its open ends in equal, opposite directions, while the loop position remains fixed. Tape movements do not interfere with each other. The open ends of each loop attach to a shared appendage, which is pulled back and forth using tensile forces. Drive and hold forces use small angle flexure bending mechanical advantage and high force density electrostatic induction methods. Tape speed results from high frequency clock speed and novel hand-off methods. Governing equations, design details and performance estimates are provided.

The U.S. patent application claims the priority of U.S. Provisional Application No. 61/462,714 filed on Feb. 7, 2011.

### CROSS REFERENCE TO RELATED APPLICATION

The inventions related to three (3) inventions shown and described in Vranish, J. M., Linear Tape Motor, U.S. Pat. No. 7,989,992B2 Aug. 2, 2011, Vranish, J. M., Stepping Flexures, U.S. Pat. No. 7,504,921, Mar. 17, 2009, (The rights to this invention are held by the United States Government.), Vranish, J. M., Charge-Driven Electrostatic Inductance, patent application filed Oct. 18, 2011, U.S. PTO Ser. No. 13/317,373 and Vranish, J. M., Device, System and Method for a Sensing Electric Circuit, U.S. Pat. No. 7,622,907, Nov. 24, 2009. [“Driven Ground”] (The rights to this invention are held by the United States Government.). The teachings of these related applications are herein meant to be incorporated by reference.

### ORIGIN OF THE INVENTION

The invention was made by John M. Vranish as President of Vranish Innovative Technologies LLC and may be used by John M. Vranish and Vranish Innovative Technologies LLC without the payment of any royalties therein or therefore. John M. Vranish is a former employee of NASA, who worked on Space Robotics and the problem of precision positioning of Space Telescope components while at NASA. His NASA work in Space Robotics made him aware of the need for an artificial muscle to move robot appendages, particularly robot hands with multiple fingers, and provided him experience in advanced capacitive sensing technology. This, in turn, lead to the Charge-Driven Electrostatic Induction ideas used to power Tape Muscle. His NASA work in precision positioning of Space lead him to explore using small angle bending techniques to move and clamp objects with precision and mechanical advantage. This NASA work also lead to his work on Tape Motors. After retiring from NASA he formed his own company, Vranish Innovations LLC, and presently continues work on his own, where he is exploring advancing and combining some of his previous work to develop viable muscle systems for space and earth robotics. Tape Muscle is a result of these efforts to date.

### FIELD OF THE INVENTION

The invention relates generally to artificial muscles. The invention relates generally to electro-mechanical actuators, electro-mechanical linear actuators and electro-mechanical motors. The invention relates generally to large force density, long stroke actuators that can hold position with power off. The invention relates generally to moderate to low speed actuators and linear motors and relates generally to actuators and motors that move using a repeated step cycle. The invention relates generally to precision position actuators and motors and to electrostatic induction motors and actuators. The invention relates more particularly to Tape Motors, Linear Tape Motors and Charge-Driven Electrostatic Induction motors and actuators.

### DESCRIPTION OF THE PRIOR ART

There is a great amount of prior art in artificial muscles, but mostly is in the research stage with very few commercial products available. The commercial products available include pneumatic muscles and electroactive polymers. Pneumatic muscle products are offered by:

### Shadow Robot Company Ltd.

### P +44 (0)207 700 2487

### 251 Liverpool Road, London, NI 1LX, UK

Electroactive Polymer muscle products are offered by:

Artificial Muscle Inc. The Artificial Muscle web site can be found by searching Artificial Muscle. Artificial Muscle Inc. is a spin-off company from SRI International that specializes in Electroactive Polymer actuators and sensors. It has been acquired by Bayer MaterialScience. The Bayer MaterialScience web site provides a telephone number contact for new customers and states that a sales representative will contact the new customer to establish a business relationship. There is no location provided for corporate HQ. Artificial Muscle Inc.

The Artificial Muscle Inc. web site advertises Viva Touch as a product for providing touch pads with a sense of interactive feel using electroactive polymer actuators. No muscle products are offered, but Robotics is listed as a company capability for custom applications.

Research and Development work in artificial muscles is varied and extensive and can easily be found with a web search on artificial muscle. The approaches include carbon nanotubes, chemically powered muscles, shaped memory alloys and additional extensive research on electroactive polymers of all kinds.

Tape Motor prior art includes: Vranish, J. M., Linear Tape Motor, U.S. Pat. No. 7,989,992B2 Aug. 2, 2011, Vranish, J. M., Stepping Flexures, U.S. Pat. No. 7,504,921, Mar. 17, 2009, (The rights to this invention are held by the United States Government.), Charge-Driven Electrostatic Induction prior art includes: .), Vranish, J. M., Charge-Driven Electrostatic Inductance, patent application filed Oct. 18, 2011, U.S. PTO Ser. No. 13/317,373 and Vranish, J. M., Device, System and Method for a Sensing Electric Circuit, U.S. Pat. No. 7,622,907, Nov. 24, 2009. [“Driven Ground”]

### SUMMARY OF THE INVENTION

It is a principal object of the present invention to provide a practical artificial muscle robot system whereby multiple actuators can be moved and positioned in coordination with each other, with independent, motion in each, by electrical means and by using drive apparatus sufficiently compact to fit on the forearm of an average sized human. It is also a principal object of the present invention to move and position each actuator with force, speed and precision using flexible tape tendons in tension and to be capable of holding position with power off. It is a further objective of the present invention to arrange the multiple tape tendons in open ended loops wherein the open ends of each loop can move without interference from the other tape tendons, wherein, each open end tape tendon in a loop is independently moved by grasp and pull coordinated actions, performed by a Clamp module and Clamp & Pull module tandem, acting directly on the tape tendon and the open ends move in equal and opposite directions. It is an objective of the present invention to camp each tape with mechanical advance using elastic bending in the tape. It is an object of the present invention to provide enhanced clamping force through tape small angle bending mechanical advantage and release through tape spring return. It is an object of the present invention to use small angle bending in the Clamp & Drive module to pull each clamped tape with mechanical advantage and to spring return the Clamp & Drive module with mechanical advantage. It is an object of the present invention to, individually, clamp each tape to the Clamp module or release it from the Clamp module using a dedicated through channel for each tape with the separation between channels in the Clamp module small. It is an object of the present invention to, individually, clamp each tape to the Clamp & Drive module or release it from the Clamp & Drive module using a dedicated through channel for each tape with the separation between channels in the Clamp & Drive module small. It is an object of the present invention to use Charge-Driven Electrostatic Induction to individually power each clamp and pull motion with adequate force, power and speed, within the tight confines of the individual through channels and the Drive & Return modules. It is an option of the present invention to use construction methods and materials that are low cost and simple.

In accordance with the present invention, a Tape Muscle includes: 1. a Set of Tape Tendons, 2. a Set of Clamp and Clamp & Drive modules, 3 an Electric Drive system and 4. a Controller. The Set of Tape Tendons are arranged in nested, open ended Tape Loops, with each Tape Loop elastically bent in a turn-around loop with the open ends extending away from the turn-around parallel to each other. The turn-around sections of each Tape Loop are nested inside each other and the open ends are all parallel to each other. The set of Clamp and Clamp & Drive modules are arranged in tandem with multiple passages in both modules such that each Tape is threaded through a dedicated passage in each module. The Clamp module is fixed, with the option to either hold or release a Tape threaded through a particular passage. The Clamp & Drive module can also hold or release a Tape threaded through a particular passage, but it can also pull the Clamp & Drive module away from the Clamp module and spring return it to its original position taking clamped Tapes with it and sliding by unclamped Tapes. Using multiple clamp and release and pull and return actions, coordinated between the Clamp and Clamp & Drive modules, each Tape Loop can be moved independent of other Tapes. The Tapes can move in groups or individually. The direction of movement can vary from Tape Loop to Tape Loop. Each Tape Loop is attached to an appendage in 2 places and actuated such that when one open end of the Tape Loop moves, the appendage moves with it and takes the other open end with it. Thus the open ends move in equal and opposite directions and the Tape Loop turn-around remains unchanged. This, in turn, allows multiple appendages to be operated by Tape Muscle without interfering with each other. The Electric Drive system provides the electrostatic induction force in each clamp channel to clamp the tape in that channel and provides the electrostatic induction force in each Drive module to pull selected Tapes away from the Clamp module taking the attached appendages along. When the electrostatic induction force is removed from the Drive module, the Drive module will spring return to rest position and when the electrostatic induction force is removed from a clamp channel, the region of tape in that channel will spring free from the channel. The Controller manages the operations of the electric power supply system and the Electric Drive system. This includes executing and coordinating the steps.

The Tape Muscle mechanical design seeks to apply minimum available force, with maximum mechanical advantage, in minimum space, while satisfying system requirements. Tape Muscle is required to pull a single Tape end with up to 100 lbf and to hold 4 appendages with up to 100 lbf each or 400 lbf total. All this is expected from a unit that can fit on a human forearm. A thin, flexible tape is required that can bend in a turn-around, thread through thin passages, bend to transfer power to appendages not aligned with the Clamp and Clamp & Drive modules and endure strong clamping forces. A thin Tape is chosen to meet the bending, flexibility and threading requirements and the thin Tape is curved in a small angle circular arc along its cross-section. During clamping, the thin, curved Tape is forced into contact with steep angle wedge surfaces in the clamp portion of the modules with the Tape edges and wedge surface at right angles to each other, so the normal friction forces at the contact are much larger than the downward clamping forces. The thin tape bends, slightly, outward upon contact, changing its curvature and slightly spreading its edges. This adds to the clamping mechanical advantage and counters buckling. On clamping release, the curved tape springs back to its rest shape and the tape edges disengage from their wedge contact surfaces for safe release. A Tendon that can bend in any direction is added to each open end of each Tape Loop so off-axis appendages can be actuated. Tape Loops use tensile forces to drive appendages in either direction. Drive is accomplished by small angle bending and spring return using a dedicated flexure in each of two Drive modules, as part of the Clamp & Drive module. Small angle bending provides large mechanical advantage in both pulling and spring return [1] and small angle bending with both the Drive module flexures and each driven Tape in tension, allows large forces to be applied without buckling. Drive flexure spring return under no load conditions, also avoids buckling while allowing the Drive cycle to reset. Small angle bending in a confined space, leads to small step size, so Tape speed is accomplished by a high step rate, or frequency response. The required frequency response is well within the state-of-the art.
The Tape Muscle Electric Drive system seeks to provide sufficient force, power and placement to drive the Tape Motor mechanical system. The requirement to place independent force and power in each of the Clamp passages (8 in a Clamp module and 8 in a Clamp & Drive module in a 4 Tape Loop muscle) leads to using electrostatics rather than electromagnetics. The size requirements are prohibitive when permanent magnets and electrical coils are used extensively. But, electrostatic force is typically much weaker than magnetic force and is too weak for Tape Muscle requirements. So, Charge-Driven Electrostatic Induction [2] was designed to induce large charge density across large insulation gaps, where electromagnetic solutions are not practical, and will be utilized in Tape Muscle. Charge-Driven Electrostatic Induction charges a stack of electrodes in a series of steps, leaving a situation where the electrode nearest the insulation gap has a large charge trapped on it, the electrode furthest from the trapped charge electrode is grounded with charge on it opposite the trapped charge electrode and all electrodes between are floating in a near charge neutral state except for a small net charge like that of the trapped charge electrode. The trapped charge on the electrode nearest the insulation gap and seeks to induce opposite charge, either across the insulation gap or in the grounded electrode on the other end of the stack of electrodes. This has the effect of greatly increasing the charge induced across the insulator and increasing the electrostatic force. The stack of capacitors is still more space efficient than electromagnetic circuitry. However, the electric field sufficient to satisfy Tape Muscle performance requirements exceeds the dielectric strength of air (or vacuum) so a bladder containing a liquid insulator (with high dielectric strength and high dielectric constant) is positioned in the gap to prevent electric breakdown and to improve the electric induction properties of the insulation gap. This combination of fixes brings electrostatic clamping performance up to required levels, within space allowed. The bladder remains in contact with the Tape at all times, with the Tape part of the electric circuit. Tape clamping squeezes the bladder slightly and the bladder deforms to allow this. Upon clamp release, the bladder and liquid returns to their pre-stressed position. A similar approach is used in the Drive modules.

### BRIEF DESCRIPTION OF THE DRAWINGS

A more complete appreciation of the invention and many of its attendant advantages will be readily appreciated as the same becomes better understood by reference to the following detailed description when considered in connection with the accompanying drawings wherein:

FIG. 1a illustrates a Tape Muscle with a single Tape Loop and two open Tape segments 1 and 2. FIG. 1a shows the Clamp and Clamp & Hold modules in tandem with the Tape segments 1 and 2 threaded through them. Section A-A for Clamp and B-B for Clamp & Drive are identified.

FIG. 1b illustrates a Tape Muscle with two nested Tape Loops and four open Tape segments, with 1 and 2 for the inner Tape Loop and 3 and 4 for the outer Tape Loop.

FIG. 1c illustrates a Tape Muscle with four nested Tape Loops and eight open Tape segments, with 1 and 2 for the inner most Tape Loop, next 3 and 4 next, then 5 and 6 and finally 7 and 8 as the open Tape segments for the outer most Tape Loop.

FIG. 2 illustrates section A-A of the Clamp module with a single Tape Loop threaded through it shown from an end view perspective.

FIG. 3 illustrates section B-B of the Clamp & Drive module with a single Tape Loop threaded through it, shown from an end view perspective.

FIG. 4 illustrates the Clamp module side section view C-C. The positioning of the Clamp Bladders in the Passages is illustrated, along with the electric field path for clamping.

FIG. 5 illustrates the Clamp & Drive module side section view D-D. The positioning of the Clamp Bladders in the Passages is illustrated, along with the electric field path for clamp. The position of the Drive Bladder is also illustrated along with the electric field path for Pull. The Pull and Spring Return flexures are illustrated along with the Pull electrode.

FIG. 6 illustrates behavior of a Flexure in bending including shape of bending, step size and bending travel as a function of bending angle.

FIG. 7a illustrates a relaxed Tape released from clamping.

FIG. 7b illustrates a bent Tape acting as a Clamping Flexure.

FIG. 8a illustrates a relaxed Drive Flexure in spring return.

FIG. 8b illustrates a bent Drive Flexure as a Pull Flexure.

FIG. 9 illustrates electric field and electric charge in a capacitor which includes a Bladder filled with a liquid dielectric. This is a NO ELECTRODES CONFIGURATION

FIG. 10 shows the electric field distribution in an INTERNAL ELECTRODES CONFIGURATION Bladder system.

FIG. 11a illustrates Clamp Bladder mechanical rest configuration.

FIG. 11b illustrates Clamp Bladder mechanical configuration when squeezed while clamping its Tape.

FIG. 11c illustrates Pull & Return Bladder mechanical rest configuration.

FIG. 11d illustrates Pull & Return Bladder mechanical configuration when squeezed while pulling the Clamp & Drive module.

FIG. 12 shows a Clamp module Two Tape Loop section A-A from an end view perspective.

### DETAILED DESCRIPTION OF PREFERRED EMBODIMENT

The invention will now be described in more detail by way of example with reference to the embodiment(s) shown in the accompanying figures. It should be kept in mind that the following described embodiments are only presented by way of example and should not be construed as necessarily limiting the inventive concept to any particular physical configuration.

In accordance with the present invention, a Tape Muscle includes: One or more Tape Tendons, A Clamp module, a Clamp & Drive module, An Electric Drive system and a Controller. Each Tape Tendon includes a Tape with a flexible Tendon attached to each end. The Set of Tape Tendons are arranged in nested, open ended Tape Loops (1, 2, 3, 4), with each Tape Loop elastically bent in a turn-around loop with its open end segments each extending away from the turn-around parallel to each other (1u and 1l for 1, 2u and 2l for 2, 3u and 3l for 3, 4u and 4l for 4). The turn-around sections of each Tape Loop are nested inside each other. Each Tape Tendon open end segment is threaded through an individual passage (2hp) in both the Clamp module and the Clamp & Drive module and each individual passage can independently clamp or release the Tape segment (1u, 1l, 2u, 2l, 3u, 3l, 4u, 4l) within it. The Clamp & Drive module includes a Clamp module (2m) and two sets of identical Pull & Return add-on components, with one set fixed to the top of a Clamp module and an identical mirror set fixed to the bottom of the Clamp module so the Clamp & Drive module can perform both clamp & release functions and pull & return motions. The Clamp modules each contain a housing (2h), a passage (2hp) for each Tape open end segment, a pair of wedge contacts (2hw) in each passage, a Tape open end segment (1u or 1l or 2u or 2l or 3u or 3l or 4u or 4l) in each passage, a Clamp Bladder system (4a1) in each passage and two stacks of Clamp Capacitors (4a) in each passage. Each set of Pull & Return add-on components includes: a Pull & Return Housing (3h1), a Pull & Return Flexure (3h2), a pair of Motion Control Flexures (3h3), a Pull & Return Electrode (3h4), a Pull & Return Bladder system (4b1) and two Stacks of Pull & Return Capacitors (4b). Mechanical advantage in both clamp & release and pull & return is achieved by using small angle bending methods. Tape speed is achieved by repeating small angle bending and spring return with sufficiently high frequency. The Electric Drive system can apply electrostatic force sufficient to clamp & release and pull & return the Tape Tendons with useful force, speed and range of motion. The Electric Drive system enables Tape Muscle to hold position with power off. The active components of the Electric Drive system are compact and locally embedded in each passage and in each Pull & Return module to allow multiple Tape Tendons to be operated in close proximity to each other. The open end segments of each Tape Loop are attached to an appendage such that the appendage moves in one direction when one open end segment is pulled and in the opposite direction when the other open end segment is pulled. In this way, the appendage can be moved, under load, in either direction, using Tape segments in tension, with the turn-around location of the Tape Loop unchanged. Open end Tape segment motion is achieved by a coordinated sequence of grasp, pull, grasp, return actions between the Clamp and Clamp & Pull modules whereby the motions of multiple Tape Loops can be performed independent of the motions of others.

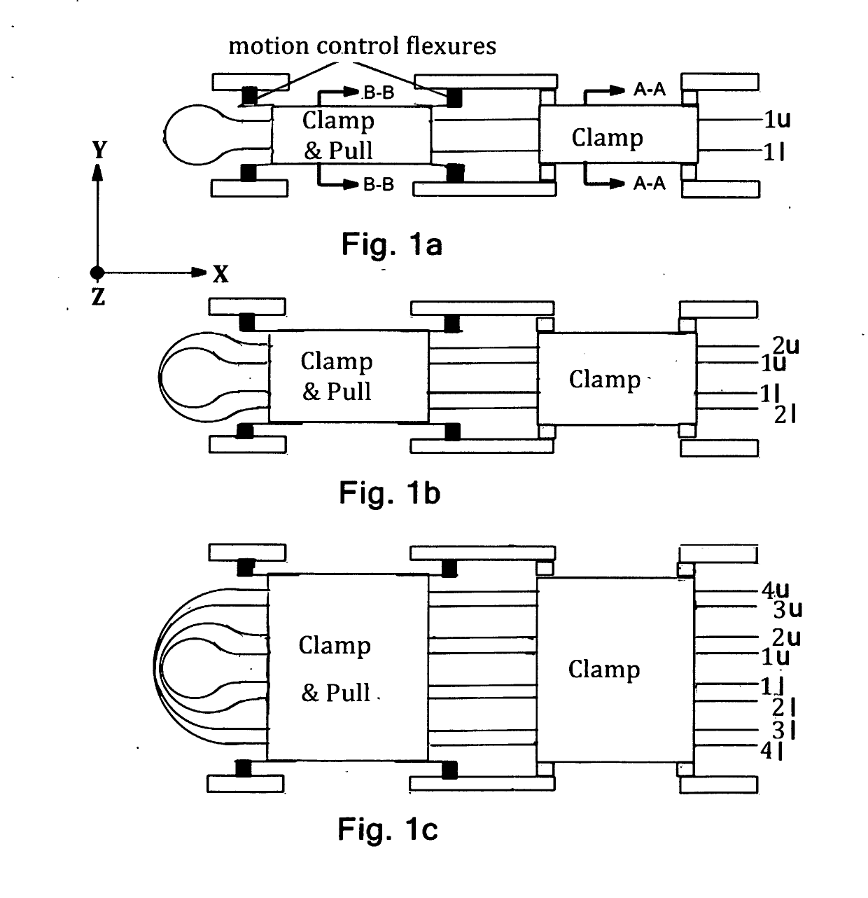

A First embodiment of a Tape Muscle is illustrated in FIGS. 1a, 1b and 1c from a side view perspective, with a single Tape Loop and two Tape Tendon open end segments shown in 1a, two Tape Loops, with four Tape Tendon open end segments shown in FIG. 1b and four Tape Loops with eight Tape Tendon open end segments shown in FIG. 1c. The configuration for three Tape Loops can be deduced from FIGS. 1a, 1b and 1c. FIGS. 1a, 1b and 1c show the systems layout for a Tape Muscle with a Clamp module and Clamp & Drive module in tandem, with the passages of the modules also lined up in tandem such that each Tape End segment can pass through both modules with minimum bending. This allows both the Clamp and the Clamp & Drive modules to independently operate on each Tape End segment and is important in executing the grasp and pull method of moving each open end Tape segment. With this arrangement, each individual Tape segment can be held in place by the Clamp module independent of Clamp & Pull module actions. When so desired, the Clamp & Pull module can position itself, grasp the Tape segment and the Clamp module can release the Tape segment, thereby turning over control to the Clamp & Drive module. The Clamp & Drive module can, then, pull the Tape Segment. At this time, the Clamp module assumes control of the Tape segment and the Clamp & Drive module repositions itself for the next Grasp & Pull cycle. The other Tape segment is grasped by the Clamp & Drive module prior to and during the Clamp & Drive module spring return so, it moves an equal and opposite direction amount during this cycle and the Tape Loop turn-around position does not change. With this concept, multiple Tape Loops can be operated simultaneously and independent of each other using a shared Clamp module and Clamp & Pull module. In this way several Tape Loops can be operated while occupying minimal space. The success of this concept depends on obtaining large mechanical advantage in clamping and in pulling in limited space so high mechanical advantage small angle bending is used [1]. Success also depends on providing adequate force in limited space at key locations to power the mechanical system so Charge-Driven Electrostatic Induction is used [2]. The discussion will first focus on the mechanical aspects of operating a Tape Muscle, assuming sufficient force is available to power the mechanics. Then, the discussion will focus on the Electric Drive system used to provide the required force, power and frequency response needed to drive the mechanical parts.

### A. FLEXURE BENDING MECHANICS

In this section we will discuss Flexure Bending Mechanics as they apply to Tape Muscle in the clamp and pull functions.

### 1. Clamping

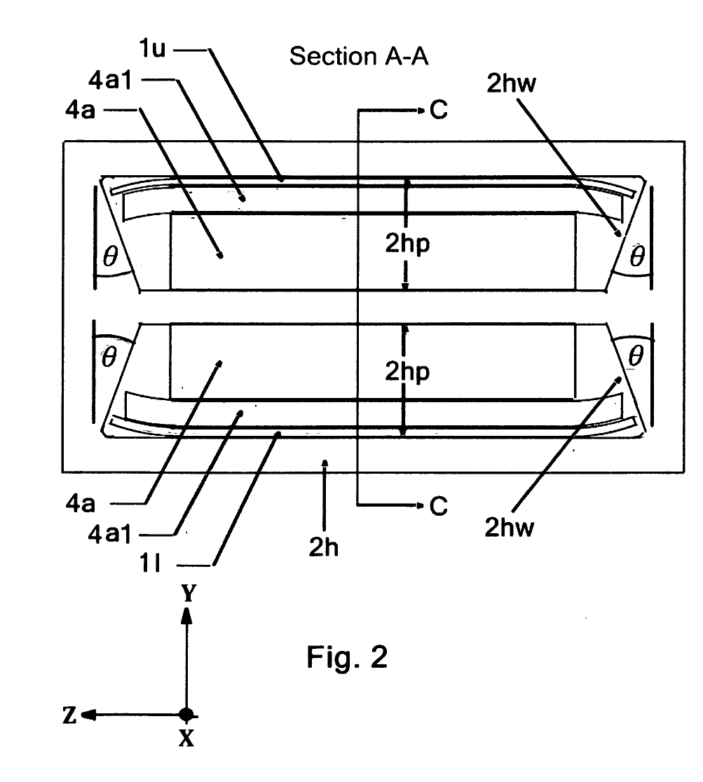

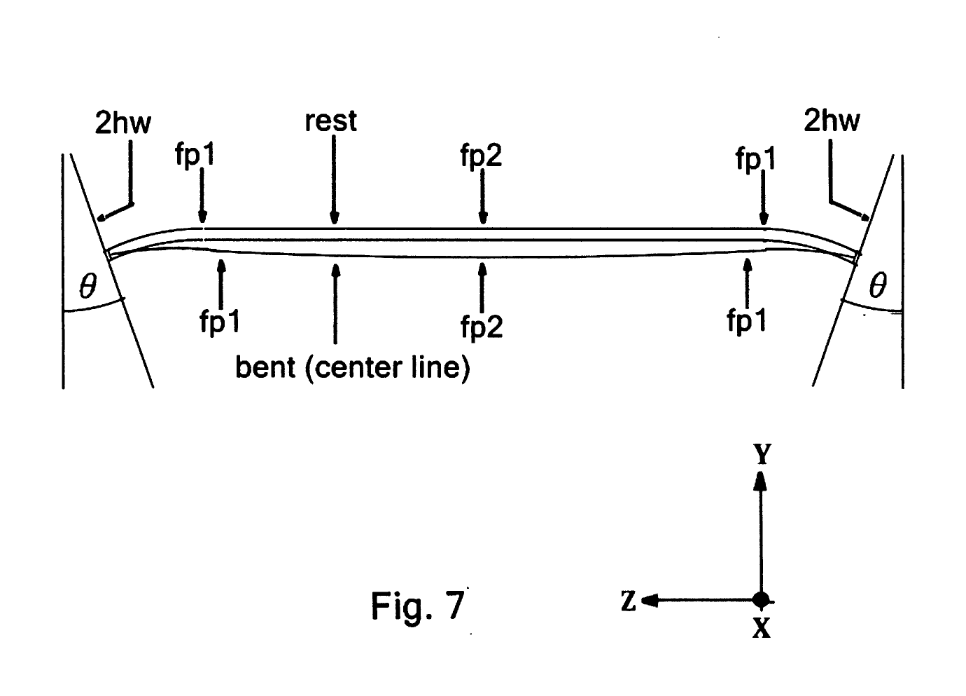

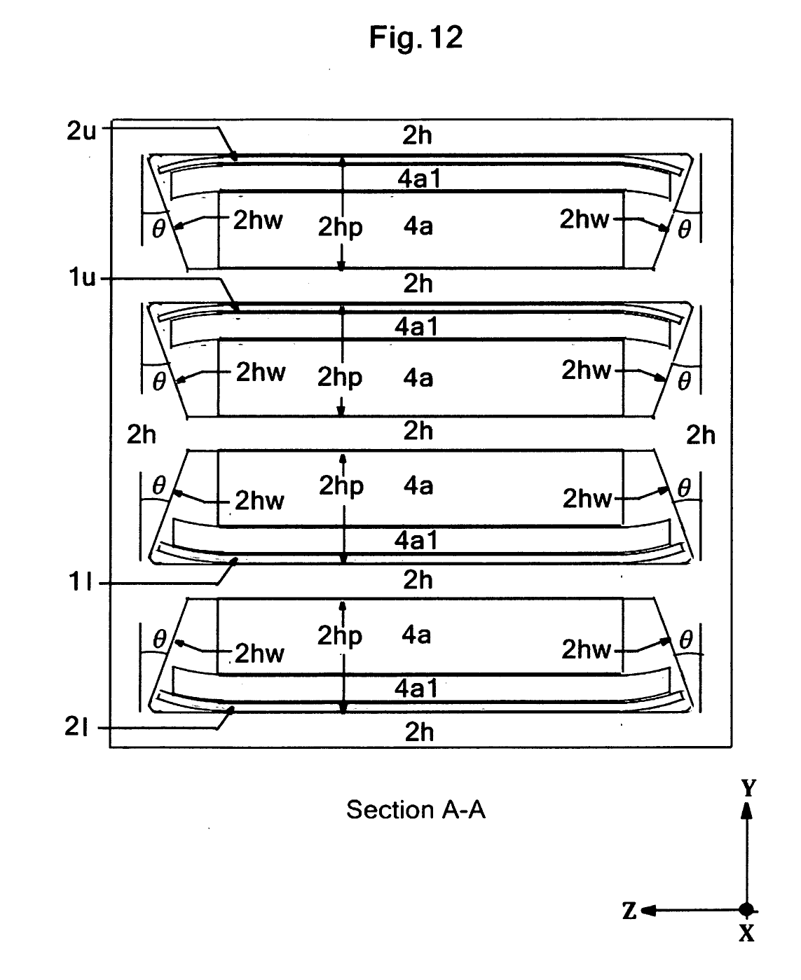

A flexure tape is slightly curved near its sides so its sides contact inclined surfaces in the Clamp or Clamp & Pull modules perpendicular (normal) to each other, as shown in FIGS. 2 and 7, FIG. 2 shows and end view of a one Tape clamp module and FIG. 12 extends the Clamp module capacity to two Tapes. FIG. 12 also shows how the Clamp module capacity can be expanded to more than two Tapes. When the curved tape contact is forced, the tape bends in response as shown in FIG. 7 and clamping mechanical advantage results with minimum sliding and loss. Charge-Induced Electrostatic Induction [2] is the means of creating the electrostatic force in our application with electric fields as illustrated in FIGS. 2, 4, 9 and 10. The flexible tape responds by bending, as shown in FIG. 7 [1][3], but, is constrained by the wedge contact surfaces. The contact surfaces have small angle wedges which match the small bending angles of the tape sides and the contact surfaces are treated to have a high coefficient of friction. The combination of small contact angles, small wedge contact angles and high static coefficient of friction on the contact surfaces provide large friction hold forces. Clamping normal forces are applied by bending rather than sliding, so the process is efficient and maximum hold force is created with minimum applied force. The tapes can be made thin and flexible with no fear of buckling because the tape widths are relatively small. Also, the small wedge angles with high coefficient of friction constitute locking angles. That is, the tape will not squirt out the top of the wedges under load. Also the tape will spring free from the wedge contacts once the clamping force is removed, with no danger of remaining stuck or jammed. Away from the constraints of the wedges, the tapes can be flattened and bent through a turn-around without regard to Tape curvature.

a. Clamping Mechanical Advantage (FIGS. 2, 6, 7).

The curved tape spreads on clamping contact and this spreading pushes against the inclined contact surface with mechanical advantage.

$$\begin{matrix}\frac{d R ( 1 - cos θ ) / d θ}{d 2 R ( θ - sin θ ) / d θ} = \frac{sin θ}{2 ( 1 - cos θ )} \\ = MA ( θ ) \\ = 11.45188277424156\end{matrix} \\ ( for θ = 5 ° ) \qquad eq ( 1 )$$

(We note that R is a slowly varying function of θ and can be treated as a constant for small angles)
We compare this with the estimate:

$$MA ( θ ) \approx \frac{1}{sin θ} = \frac{1}{sin 5} = 11.4737132456699 \qquad eq ( 2 )$$

And find close agreement.
b. Clamping Friction Hold Force

We can coat the contact surfaces with nickel so that contact surfaces do not corrode and friction hold performance remains consistent.

μₛ=0.7(dry nickel on nickel) eq (3)[4]

We want a friction holding force >100 lbf so we will need at least 143 lbf clamping force and requires the Charge-Driven Electrostatic Induction force of:

$$\frac{143 lbf}{MA ( θ )} = \frac{143 lbf}{11.4518827742156} = 12.48702967 lbf \qquad eq ( 4 )$$

c. Tape Contact Stresses
We now see if the thin tape can support the clamping force contact stresses.
Using steel as our Tape and Clamp material and considering a Tape thickness of 0.005 in. and a contact length of 2 in. with a tape width of 2 in, we have

$$\frac{143 lbf}{A} = \frac{143 lbf}{0.005 in \cdot 2 in} = 14 , 300 psi \qquad eq ( 5 )$$

We find the contact stresses acceptable, especially for spring steel.
We will also see how the Young's Modulus compression affects the thin tape.

$$\begin{matrix}F = E \cdot A \cdot \frac{Δ L}{L} & eq ( 6 ) [ 5 ] \\ F = 143 lbf = 30 ( E 6 ) psi \cdot 0.005 in \cdot 2 in \cdot Δ L / 1 in ; \\ Δ L = 0.000476666667 in & eq ( 7 )\end{matrix}$$

This value seems reasonable, especially when it is shared over 2 contact surfaces pushing towards each other, with some of the elastic deformation being taken up by the contact structure constraining the tape.

### 2. Drive

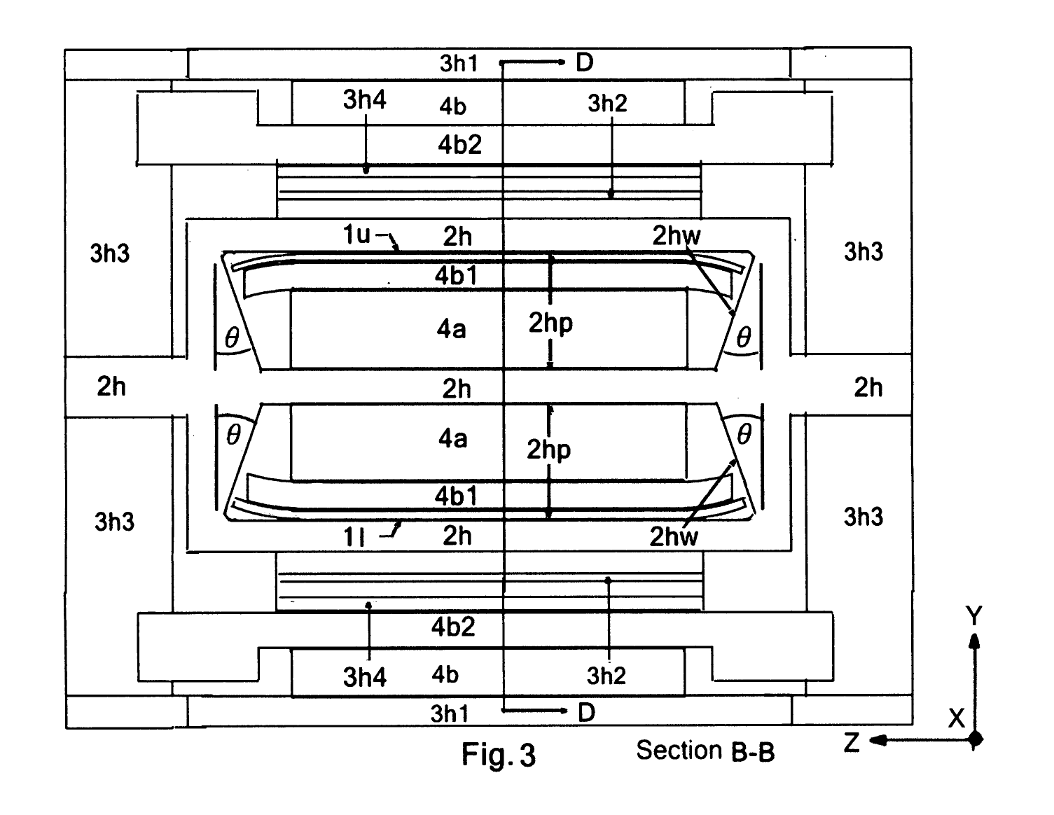

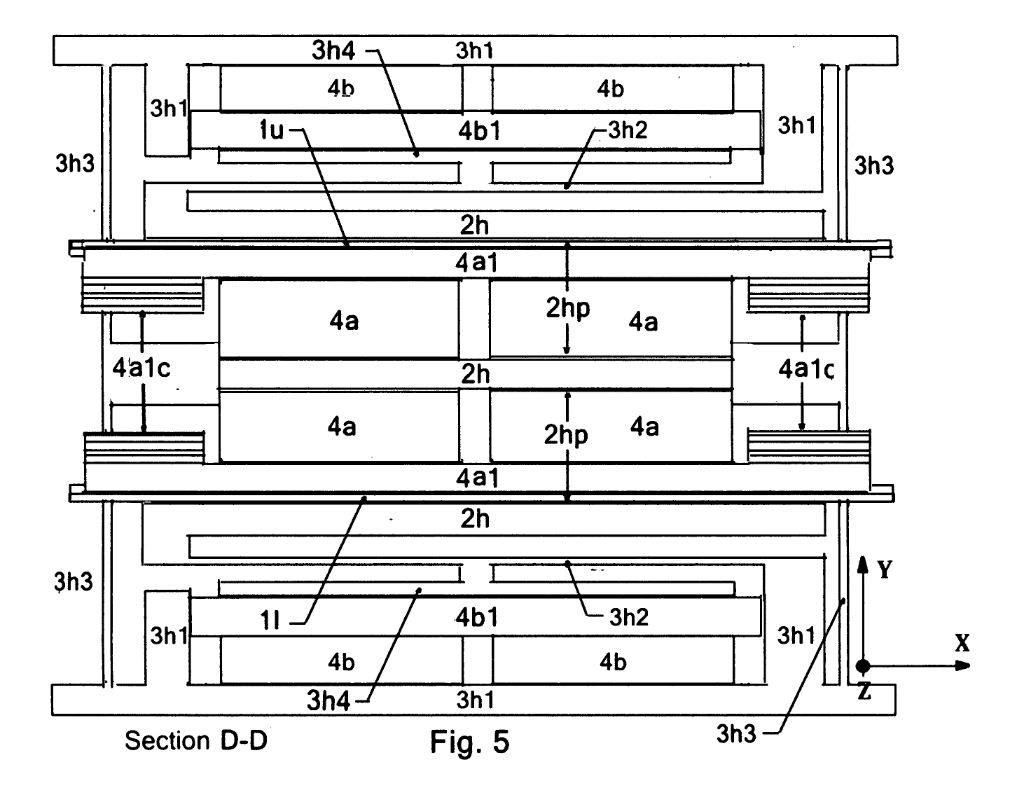

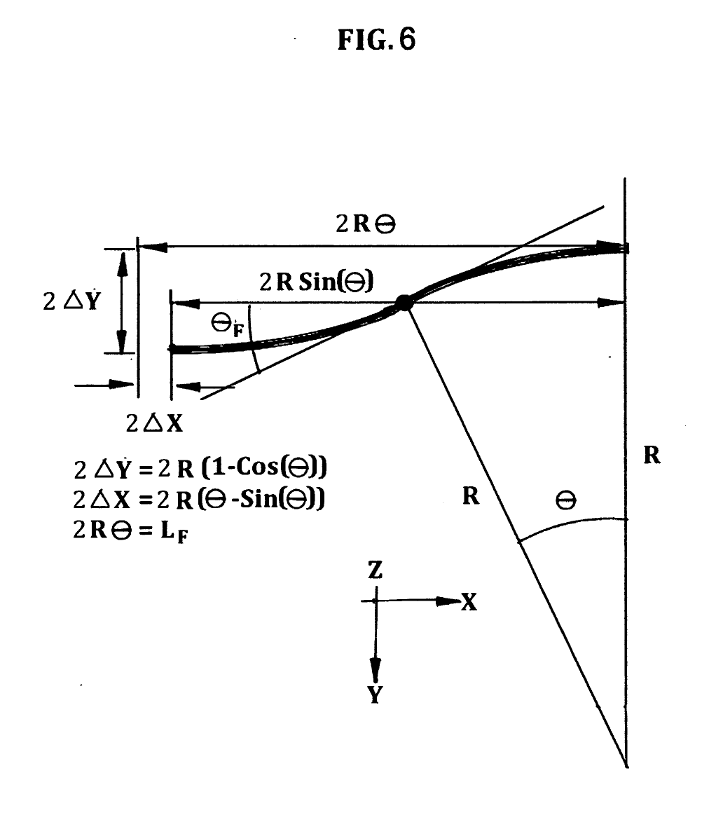

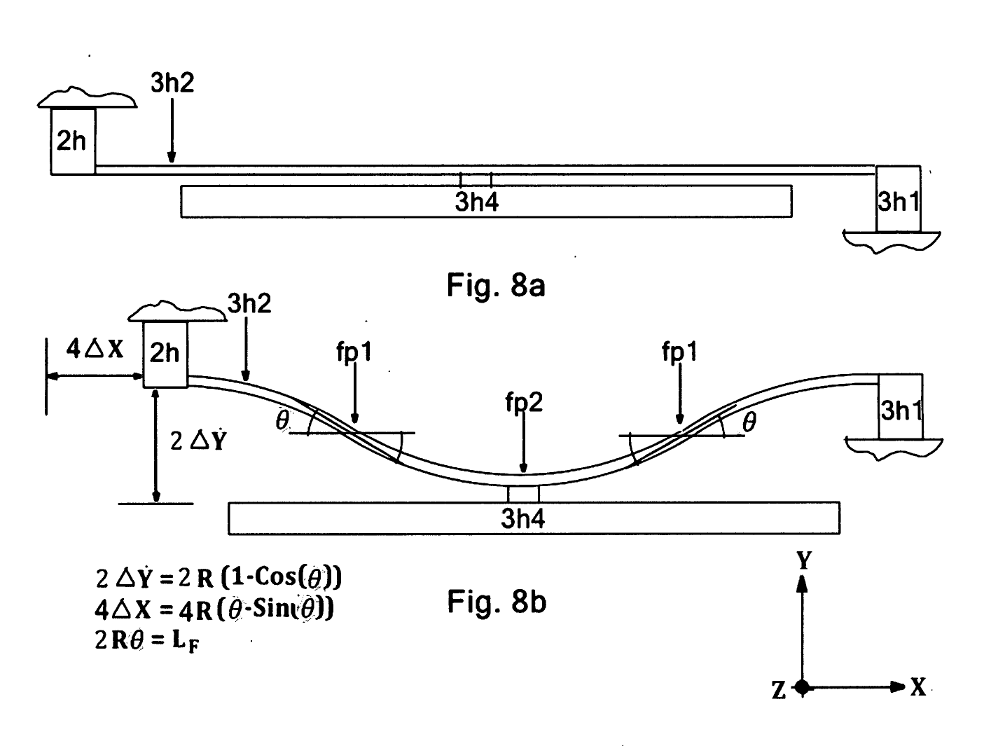

Drive comprises both Pull and Spring Return. FIGS. 3, 5, 8a and 8b illustrate how a Pull & Return module is constructed and how it functions. FIGS. 6 and 8b show more detail on how the flexures bend and the step size and travel distance involved in the bending. The same equations apply to both the Clamp and Pull functions. The Pull & Return module has sufficient room to make its' flexures long so its step size can be made relatively long with small maximum bending angles and large mechanical advantage. There are two (2) Pull & Release modules for each Clamp & Pull module (top and bottom) and pull force does not depend on a coefficient of friction to apply its forces. As shown in FIGS. 5 and 8a, a Pull & Return flexure pulls against a mechanically grounded structure on one side and on the body of the Clamp & Pull module on the other which pulls the Body towards the grounded structure during bending and returns the Body when the Charge-Driven Induction force is removed and the flexure spring returns to neutral.

a. Step Size and Mechanical Advantage (FIGS. 5, 6, 8b)

From FIG. 8b we can see that 2 flexures are involved in the Drive/Return sequence and each of the 2 flexures bends according to FIG. 6 so:

2R(1−cos θ)=2ΔY, 4R(θ−sin θ)=4ΔX eq (8)[1]

Which gives a mechanical advantage of:

$$\begin{matrix}\frac{d 2 Δ Y / d θ}{d 4 Δ X / d θ} = \frac{2 R sin θ}{4 R ( 1 - cos θ )} \\ = \frac{sin θ}{2 ( 1 - cos θ )} \\ = MA ( θ ) \\ = 11.4518827742156 ( θ = 5 ° )\end{matrix} \qquad eq ( 9 )$$

b. Performance Estimates

We make the Pull & Return flexures as long as possible (FIGS. 5, 8a) to gain Drive force, but we are constrained in the pull distance required to obtain reasonable step size with large mechanical advantage. We choose:

$$\begin{matrix}2 L = 0.5 in . & eq ( 10 ) \\ \frac{0.25}{\frac{π}{36}} = R = 2.8647889756541 in , , \\ θ = 5 ° = \frac{π}{36} rad & eq ( 11 )\end{matrix}$$

With an expected step size of:

4R(θ−sin θ)=2ΔX(ΔR=0)=0.0012687560463 in. eq (12)

From a vertical null of:

$$2 R ( 1 - cos θ ) = 2 Δ Y ( Δ R = 0 ) = 0.0218027739116 in \qquad eq ( 13 )$$

To obtain a pull force equal to the maximum hold force of the Clamp, we need an electrostatic attraction force in the Drive portion of the Clamp & Drive module of:

$$\begin{matrix}\frac{100 lbf}{MA ( θ )} = \frac{100 lbf}{11.4518827742156 ( θ = {5}^{°} )} \\ = 8.7321885817024 lbf\end{matrix} \qquad eq ( 14 )$$

Where the Drive force comes from 2 sources, top and bottom on the Clamp & Drive module, the attraction force given by eq. (14) is split between the 2 sources.

Using a 5 khz drive cycle, we expect a Tape speed of 6.4378082315 in/sec which is adequate for fast reaction applications. The drive forces are not limited by friction hold slipping like the clamping forces. This opens the possibility of trading increased speed and step size for mechanical advantage and pulling force without penalizing the muscle system performance overall.

### 3. Tape Loop Bundles

Tape Loops can be grouped in bundles of 1, 2, 3 or 4, according to FIGS. 1a, 1b and 1c, with the Tape Loops nested inside each other such that each loop can move in either of 2 directions without interference from other Tape Loops. Each Tape Loop passes through the Clamp module and the Clamp & Drive module 2 times. The Clamp module and Clamp & Drive module have multiple passage ways with each passage way dedicated to an individual Tape Loop. Each passage way can clamp or release the tape passing through it, independent of other tapes and other passage ways. Thus, one side of an individual Tape Loop can be pulled in one direction by the Clamp & Drive module and the other side can be returned in the opposite direction by the same Clamp & Drive module during its drive flexure spring return. The Clamp module can, synchronously, operate with the Clamp & Drive module to secure one end of the tape while the other end is being either pulled or returned. In this manner, each tape can be individually operated to move in either of 2 opposite directions, to use pull forces to move a load in either direction and to use spring return under no load conditions. This is important when using a thin, flexible tape that can support large loads in tension, but will buckle against large loads in compression. When a Clamp & Drive module moves, each side of an individual Tape Loop has the option to move with the Clamp & Drive module or to stay in position and the Clamp module can support this decision by either allowing that side of the Tape Loop to move or by holding it in place. Since each side of each Tape Loop can be independently secured to or released from the Clamp module and Clamp & Drive module on command, multiple Tape Loops can be independently operated, while sharing a common Clamp module and a common Clamp & Drive module. This allows multiple tape actuators to be operated in a compact form factor, which is critical to its practical implementation in robot applications. When multiple tape actuators are operated simultaneously, the drive force from the Clamp & Drive module must be shared by the actuators being operated. If available drive force is inadequate, Tape Loop sides can be operated individually, with these individual operations sequenced to provide the desired systems operational outcome. There is also the option of operating subgroups of Tape Loop sides simultaneously and sequencing the operation of these subgroups to provide the desired systems operational outcome.

### 4. Drive Sequence for Tape Loop Bundles

The Drive Sequences for motion control of bundled Tape Muscles will now be discussed. We seek to share hardware components and vary the Drive Sequence to optimize performance with minimum compromises in performance. First a Single Tape Loop will be discussed. This Drive Sequence will be extended to a Two (2) Tape Loop system and from there to Three (3) and Four (4) Tape Loops. At some point, it is best to add a new set of Drivers and start adding Tape Loops to this new Clamp and Drive pair of modules. As a by-product of the drive sequence discussions, the reasons for using a tandem of a Clamp and Clamp & Drive modules will become clear.

For brevity, Clamp module is represented by the letter C and the Clamp & Drive module is represented by C&D.

We propose a Drive Sequence using Near Simultaneous Hand-Offs We postulate a tape can be grasped by C instances before being released by C&D (or vice versa) to prevent any backwards slip under load. We postulate this can be accomplished by a very small time offset in the otherwise simultaneous grasp and release commands without requiring 2 separate commands of first grasp and then release. For all practical purposes, the commands would be simultaneous and tape speed would be maximized. Even without a time offset, simultaneous hand-offs are safe. Any time differences between grasp and release would be very small because modern electronics can time events with great precision and the load and tape have mass and inertia and take time to move. Electronic functions are typically much faster than the mechanical reactions to these functions.
a. Single Tape Loop Case (FIG. 1a) (Note* Tape segment 1u and Tape segment 1l are both part of Tape Loop 1.)
   1. Tape segment 1a is moved in Tension in +X Direction. Tape segment 1b is Moved in No-Load Compression in −X Direction.
   First, C&D clamps Tape 1u, C releases Tape 1u, C&D releases Tape 1l, C releases Tape 1l.
   Second, C&D drives Tape 1u in +X direction. (This, in turn, moves an appendage attached to Tape segment 1u using tensile forces in Tape 1u and Tape 1l is freed to move in −X direction. This, in turn, allows Tape 1u and Tape 1l to be connected to the same appendage and to provide 2 way motion for the appendage using Tape tensile forces.)
   Third, C clamps Tape 1u, C&D releases Tape 1u, C&D clamps Tape 1l, C releases Tape 1l.
   Fourth, C&D spring returns to start, slides past Tape 1u, moves Tape 1l in −X direction. Tape 1l slides past C. We return to the First step and a new cycle is started. (4 total sequential steps are involved, 2 of them require inertial movement of the C&D module and 1 of the appendage.)
   2. Tape segment 1b is moved in Tension in +X Direction. Tape segment 1u is Moved in No-Load Compression in −X Direction.
   First, C&D clamps Tape 1l, C releases Tape 1l, C&D releases Tape 1u, C releases Tape 1u.
   Second, C&D drives Tape 1b in +X direction. (This, in turn, moves an appendage attached to Tape 2 with tensile forces in Tape 2 and Tape 1 is free to move in −X direction. This, in turn., allows Tape 2 and Tape 1 to be connected to the same appendage and to provide 2 way motion for the appendage using Tape tensile forces.)
   Third, C clamps Tape 1l, C&D releases Tape 1l, C&D clamps Tape 1u, C releases Tape 1u.
   Fourth, C&D spring returns to start, slides past Tape 1l, moves Tape 1u in −X direction. Tape 1u slides past C. We return to the First step and a new cycle is started. (4 total sequential steps are involved, 2 require inertial movement of the C&D module and 1 of the appendage.)
b. Two Tape Loop Case (FIG. 1b) (Note* Tape 1u and Tape 1l are part of a single Tape Loop. Tape 2u and Tape 2l are part of a single Tape Loop.)
   1. Tape Loop 2, Comprising Tape 2u and Tape 2l is moved in +X Direction Tension for Tape 2u and in −X no-load compression for Tape 2l. Tape Loop 1, Comprising Tape 1u and Tape 1l, remains held in place.
   First, C&D clamps Tape 3 and releases Tapes lu, 1l, 2l. C clamps lu, 1l, C releases Tapes 2u, 2l.
   Second, C&D drives Tape 2u in +X direction, Tape 2u moves with C&D and slides past C. Tape 2l is freed to slide past C and C&D. C.&D slides past Tape 1u and Tape 1l. (This, in turn, moves an appendage attached to Tape 3 with tensile forces in Tape 3 and Tape 4 is freed to move in −X direction. This, in turn, allows Tape 2u and Tape 2l to be connected to the same appendage and to provide 2 way motion for the append-age using Tape tensile forces.)
   Third, C&D clamps Tape 2l. C releases Tape 2u. C clamps Tapes 1u and 1l.
   Fourth, C&D spring returns to start, slides past Tapes 1u, 1l, 2u and takes Tape 2l in −X direction with it. Tape 2u slides past C and we return to the First step where, a new cycle is started. (4 total sequential steps are involved, 2 require inertial movement of the C&D module and 1 of the appendage.)
   2. Tape Loop 1 Comprising Tapes 1u and 1l is moved with Tape 1u in Tension in +X Direction and Tape 1l in no-load Compression in −X Direction. Simultaneously, Tape Loop 2 Comprising Tapes 2u and 2l is moved with Tape 2l in Tension in +X Direction and Tape 2u in no-load compression in −X Direction.
   First, C&D clamps Tapes 1u, 2l and releases Tapes 1l, 2u, C releases Tapes 1u, 1l, 2u, 2l.
   Second, C&D pulls Tapes 1u, 2l in +X direction, Tapes lu, 2l slide past C, C&D slides past Tapes 1l, 2u
   u and Tapes 1l, 2u are freed to slide past C. (This, in turn moves 2 appendages, each attached to 2 Tapes of each Tape Loop, so as to provide 2-way movement for 2 appendages using the Tapes in tension where they are strongest.)
   Third, C&D clamps Tapes 1l, 2u and releases Tapes 1l, 2l. C clamps Tapes 1u, 2l and releases clamped Tapes 1l, 2u.
   Fourth, C&D spring returns to start, slides past Tapes 1u, 2l, Tapes 1l, 2u move with C&D and slide past C. We return to the first step where a new cycle is started. (4 total sequential steps are involved, 2 of them require inertial movement of the C&D module and 1 of the appendage.)
c. Three Tape Loop Case (This case is implied by looking at FIGS. 1a, 1b and 1c.)
As in the pattern established for the Single Loop and Two Loop cases, 4 total sequential steps are required, 2 require inertial movement of C&D and 1 of the appendages.
d. Four Tape Loop Case (FIG. 1c)
As in the pattern established for the Single Loop, Two Loop and Three Tape Loop cases, 4 sequential steps are required, 2 require inertial movement of C&D 1 of the appendages.

### 5. Drive Sequence Conclusions

a. It seems any combination of Tape Loop motions is possible using the same Drive Sequence. It is just a matter of which Tapes are clamped to C&D and C, in what order and with which timing sequence. The system will be able move all tape loops clockwise or counterclockwise or some clockwise and some counterclockwise. It will also be able to hold some stationary.
b. There are limitations on how many tape loops can be handles by a single C and C&D pair. At some point, the Driver cannot support the cumulative load. The clutter of multiple tapes can become too high because they stack one on top of each other. When a stack gets high enough, torques result which must be managed by the C&D module.
c. Large multiples of tape loops will require a combination of multiple C and C&D sets and multiple tape loops in each set. Three tape Loops seems a comfortable number for each C and C&D Drive Set but, four may be acceptable and practical.
d. Tape Speed of 6.5 in per second, requires a Drive cycle of 6 steps (4 sequential steps for hand-offs, 1 Drive step and 1 Drive Return step). The Charge-Driven Inductance system requires 3 sequential steps to perform each Clamp and each Drive. Clamp release and Drive return can be performed in a single step, simultaneously with the Hand-Off steps. A 30 khz micro-controller step execution rate is adequate to meet Tape Speed requirements. Higher Tape Speed with faster micro-controllers are possible with current art if needed.

### 6. Performance Estimates

Numerical estimates are based on a 2 in. wide, 0.005 in thick tape curved in a 10 deg included angle with each of the sides of the tape at a 5 deg angle. Five deg is the angle of contact. The wedge angles in the Clamp are also 5 deg such that the tape edges and wedge contact surfaces are normal to each other.

a. Clamp & Release Module Size Estimates

### For 1 Tape

1/32 in core+ 1/32 in stand-off+ 1/32 in flexure contact+0.022 in flexure arc+0.005 in flexure thickness+0.028 in insulation=0.15375 in. Stand-alone add 1/32 in =0.185 in height.

### For 1 Tape Loop

1/32 core+ 1/32×2 stand-off+ 1/32×2 flexure contact+0.022×2 flexure arc+0.005×2 flexure thickness+0.028×2 insulation=0.25625 in total+ 1/32×2=0.31875 in stand-alone height.

### For 2 Tape Loops

0.25625+2×(0.15375)=0.56375 in total+ 1/32×2=0.6265 in stand-alone height.

### For 3 Tape Loops

0.56735+2×(0.15375)=0.87125 in total+ 1/32×2=0.93375 in stand-alone height.

### For 4 Tape Loops

0.87125+2×(0.15375)=1.17875 in total+ 1/32×2=1.24125 in stand-alone height.

b. Clamp & Pull Module Estimates

We drive both above and below the clamp portion of the Clamp & Pull Module so we estimate the size of the bottom Driver, multiply it by two and add it to the Clamp & Pull module to estimate the Clamp & Pull module height.

c. Pull & Return Module Estimates

We, now estimate the size of the bottom Pull & Return module. We use the bottom of Clamp Housing as part of the Pull & Return module structure.

### 1 Tape

0.020 in EDM thru way+ 1/32 in step+ 1/32 in moving electrode+ 1/32 in travel+ 1/32 in base thickness=0.145 in total for bottom drive×2=0.290 total for top and bottom drives.

d. Module Height Summary

### 1 Tape Loop:

Clamp Module: 0.31875 in high

Clamp & Drive Module: 0.60875 in high

### 2 Tape Loops:

Clamp Module: 0.6265 in high

Clamp & Drive Module: 0.9165 in high

### 3 Tape Loops:

Clamp Module: 0.93375 in high

Clamp & Drive Module: 1.22375 in high

### 4 Tape Loops:

Clamp Module: 1.24125 in high

Clamp & Drive Module: 1.53125 in high

e. Module Width Summary

Clamp & Release module (all): 2 in wide tape+ 1/32×2 in wide wedge contact surfaces+0.020×2 in EDM throughways+ 1/32×2 in support side structure=2.165 in total

Clamp & Pull module (all): Clamp & Release module width+Motion Control Side Flexures=1.165 in + 1/16 in flexures×2+ 1/32 in×2 flexure support structure=2.3525 in total.

### B. CHARGE-DRIVEN ELECTROSTATIC INDUCTION FORCES

We will now examine the Charge-Driven Electrostatic Induction forces that will be used to clamp and drive the Tape Muscle. Charge-Driven Electrostatic Inductance was chosen as the means to power Tape Muscle over electromagnetics because, in the Tape Muscle application, using windings and permanent magnets to independently control several nested tape loops would take up too much space in too confined an area to be practical so we look to electrostatic power as a substitute. But, electrostatic power is typically too weak to compete with magnetics so we look to Charge-Driven Electrostatic Induction [2] as a technique to boost the electrostatic power and force sufficient to compete with magnetics. Charge-Driven Electrostatic Inductance accomplishes this by charging a stack of capacitors in series so as to induce large charge across relatively large insulation gaps, adequate to power the Tape Muscle and using a novel method to charge the stack of capacitors in a series of steps using a safe, working level voltage so as to reduce the size of the power electronics and to maintain safe, low voltage operating conditions. [2]

The Tape Muscle uses Charge-Driven Electrostatic Induction Forces [2] to selectively clamp sections of tape and to drive clamped tape. In the clamping application, tape movement is very small. The curved portions of the tape rest in near contact on 2 wedge sections of a Clamp and Clamp & Drive module. When electrostatic force is applied in a module, the tape is pulled to contact the 2 wedged sections and, upon contact, spreads to clamp itself against the wedge sections with mechanical advantage as described earlier. The straight portion of the Tape acts as a target electrode opposite the Charge-Driven Electrostatic Induction drive electrodes embedded in each passage of the Clamp and Clamp & Drive modules resulting in a uniform electric field in the insulation gap between Tape and drive electrodes.

The electric field across an air insulation gap, adequate to Clamp and Drive the Tape Muscle will cause air in the gap to breakdown so a liquid insulator and dielectric, contained inside a bladder is used. The bladder and Liquid Dielectric Insulator system are described, with the governing equations and expected performance.

### 1. Governing Equations

Governing equations for Charge-Driven Electrostatic Induction in the Tape Muscle Application (These equations are taken from ref. [2] and the explanation that follows is not as complete as that provided in the reference.)

We know the force E_{IND} on induced charge Q_{IND} in electric field E_{IND} is given as

Q_{IND}E_{IND}=F_{IND} [6]eq (15)

We also know the charge (Qₜ) trapped on the drive outer electrode of the stack of capacitors is

Qₜ=V_{S}(C₁+C₂) [7]eq (16)

### Where:

V_{S}=source voltage
C₁=gap capacitance
C₂=capacitance of each individual capacitor in the stack of capacitors
This trapped charge Qₜ has 2 paths to ground induction, across the gap to the Tape (C₁) and back through the stack of capacitors to ground (C_{ST}).

$${Q}_{IND} = {Q}_{t} \frac{{C}_{1}}{( {C}_{1} + {C}_{st} )} = \frac{{V}_{S} ( {C}_{1} + {C}_{2} ) {C}_{1}}{( {C}_{1} + \frac{{C}_{2}}{n} )} = \frac{{V}_{S} n ( {C}_{1} + {C}_{2} )}{( n {C}_{1} + {C}_{2} )} \qquad eq ( 17 )$$

### Where:

$${C}_{st} = \frac{{C}_{2}}{n} ( n = number of capacitors in stack ) \qquad [ 2 ]$$

We rearrange eq (17)

$${Q}_{IND} = {V}_{S} n {C}_{1} \frac{( {C}_{1} + {C}_{2} )}{n {C}_{1} + {C}_{2}} = {V}_{S} n {C}_{1} \frac{( 1 + \frac{{C}_{2}}{{C}_{1}} )}{( n + \frac{{C}_{2}}{{C}_{1}} )} \qquad eq ( 18 )$$

We now know Q_{IND} and we know

$$\frac{{Q}_{IND}}{{C}_{1}} = {V}_{IND} = \frac{{Q}_{st}}{( {C}_{1} + {C}_{st} )} \qquad eq ( 19 )$$

We also know C₁, d₁ and Cₛₜ and we provide a straight segment in the Tape cross section so the electric field is uniform throughout the electrode area affected. So, we can obtain the electric field by simple division resulting in:

$$\frac{{V}_{IND}}{{d}_{1}} = {E}_{IND} \qquad [ 8 ] eq ( 20 )$$

We substitute for V_{IND} in eq (17) using eq (16) which leads to:

$$\frac{{Q}_{IND}}{{C}_{1} {d}_{1}} = {E}_{IND} \qquad eq ( 21 )$$

And since the induced charge is evenly distributed over the parallel drive and tape electrodes we can obtain the induced force by simply multiplying the induced charge by the induced electric field acting on the induced charge.
From eq (15) we have:

$$\frac{{Q}_{IND}^{2}}{{C}_{1} {d}_{1}} = {F}_{IND} \qquad eq ( 22 )$$

Substituting eq (18) into eq (22) we have:

$${F}_{IND} = \frac{{V}_{S}^{2} {n}^{2} {C}_{1}}{{d}_{1}} {( \frac{( 1 + \frac{{C}_{2}}{{C}_{1}} )}{( n + \frac{{C}_{2}}{{C}_{1}} )} )}^{2} \qquad eq ( 23 )$$

Q_{IND}, Qₛₜ, C₁ and C₂ are on a per unit area basis.

### 2. Performance Estimates

Choose C₁ with an air gap d₁=0.010 in, ∈_{R}=1 and ∈₀=8.8541878176 (E−12) F/m. Choose C₂ with d₂=0.00043 in (11 um), ∈_{R}=20. [9] Choose n=100 interior electrodes where C₂ capacitors are stacked on top each other. These choices result in C₂/C₁=465.1162790697674.
We will evaluate eq. (28) in steps.
We first evaluate a dimensionless piece of eq. (23).

$$\begin{matrix}{( \frac{( 1 + \frac{{C}_{2}}{{C}_{1}} )}{( n + \frac{{C}_{2}}{{C}_{1}} )} )}^{2} = {( 0.8248148148148 )}^{2} \\ = 0.680319478738 ( dimensionless )\end{matrix} \qquad eq ( 24 )$$

We pause to check the remainder of eq. (23) for dimensional consistency.

$$\frac{{V}_{S}^{2} {n}^{2} {ɛ}_{0} {ɛ}_{R} A}{{d}_{1}^{2}} = \frac{Volts}{meter} \cdot Volts \cdot Farads = Newtons of force \qquad eq ( 25 )$$

We now evaluate the remaining piece of eq. (23)

$$\frac{{{V}_{S}^{2} ( 100 )}^{2} \cdot 8.8541878176 ( E - 12 ) F / m \cdot 20 \cdot A ( {m}^{2} )}{{( 11 E - 6 m )}^{2}} = {V}_{S}^{2} ( 14635.021186115702 ) A ( {m}^{2} ) \qquad eq ( 26 )$$

We remind ourselves that eq. (26) provides force in newtons before the dimensionless correction factor of eq. (24).
We convert this calculation to express area in sq. inches (A in²):

$${V}_{S}^{2} \frac{14635.021186115702}{{( 39.37 )}^{2}} = {V}_{S}^{2} ( 9.4419680362688 ) A ( {in}^{2} ) newtons \qquad eq ( 27 )$$

We now multiply eq. (27) and the dimensionless correction factor of eq. (24) to obtain our corrected result in eq. (28).

V_{S}²(9.4419680362688)·0.680319478738 A(in²)=V_{S}²·6.4235547726952 A(in²)N

F=V_{S}²·6.4235547726952 A(in²)Newtons=V_{S}²·1.4440725551743 A(in²)lb f eq. (28)

For V_{S}=100 volts, we calculate 14440 lbs for a 1 in² section of tape. This seems very optimistic.

We are looking at the rough equivalent of 100×100 or 10 Kvolts across an air gap of 0.010 in so we can expect some exceptional electrostatic force. If the theory is correct, perhaps it would be useful to consider reducing the number of electrodes to save cost and space.

We explore reducing the number of electrodes to n=50 from n=100. Since F_{IND} is proportional to n², we estimate force is reduced by a factor of four to 3610 lbs for a 1 in² section of tape. If we use n=25, we estimate the clamping force to be 902 lbs for a 1 in² section of tape. With n=25, we are looking at the rough equivalent of 2.5 KV across an air gap of 0.010 in. This is still a large value across a small air gap and will induce a large electric charge.

### 3. Air Gap Breakdown

We check against air dielectric breakdown or sparking. We find the breakdown voltage for dry air is 3 (E6) V/m [10] or 762 V over 0.01 in.

With the air gap limited to a maximum of 762 Volts what force is available?

$${C}_{1} V = Q \\ \begin{matrix}{C}_{1} V \frac{V}{{d}_{1}} = F \\ = \frac{{ɛ}_{0} {ɛ}_{R} A}{{d}_{1}} \frac{{V}^{2}}{{d}_{1}} \\ = \frac{8.854 ( E - 12 ) F / m \cdot {( 762 V )}^{2} A ( {in}^{2} )}{( 39.37 in / m ) {( 0.01 in )}^{2}} \\ = 0.0013058221935 A ( {in}^{2} ) Newtons\end{matrix} \qquad eq . ( 28 )$$

Upper limit of an electrostatic force before air breakdown

### Where:

$$\frac{762}{0.010} = E ( volts per inch ) = 76200 \frac{V}{in} \qquad eq . ( 29 )$$

The available force is too small to be useful. We seek a workaround.

### 4. Liquid Dielectric Workaround

We explore a workaround using a liquid dielectric that will not breakdown under high voltage. A capable liquid appears to be distilled water, with its properties of ∈_{R}=80.1 at 20° C. [11] and dielectric strength=65 to 70 times that of air at 20° C. [12] Purified or deionized water can also be used.

To satisfy the mechanical requirements of moving the Tape 0.010 in for Clamping and Drive, we use distilled water inside a bladder with a minimum liquid thickness of 0.010 in and a maximum liquid thickness of 0.020 in. The minimum liquid thickness provides a force upper limit at breakdown of:

$$\begin{matrix}{C}_{1} V \frac{V}{{d}_{1}} = F \\ = \frac{{ɛ}_{0} {ɛ}_{R} A}{{d}_{1}} \frac{{V}^{2}}{{d}_{1}} \\ = \frac{8.854 ( E - 12 ) F / m \cdot 80.1 {( 65 \cdot 762 V )}^{2} A ( {in}^{2} )}{( 39.37 in / m ) {( 0.01 in )}^{2}} \\ = 441.919611296129 A ( {in}^{2} ) Newtons \\ = 99.3474804603044 A ( {in}^{2} ) lbf\end{matrix} \qquad eq ( 30 )$$

As an upper limit before breakdown.
With a distilled, purified or deionized water maximum thickness of 0.020 in, we have:

24.8368701150761 A(in²)lb f eq (31).

These results are a significant improvement over air, but it assumes the gap is filled with distilled water, which requires a Bladder system. We explore two Bladder Design configurations, an INTERNAL ELECTRODES CONFIGURATION and a NO ELECTRODES CONFIGURATION. Both configurations use three capacitors in series, an isolation capacitor between the Drive Electrode and the liquid insulation dielectric, a capacitor across the liquid dielectric between the two opposite inner surfaces of the Bladder and an isolation capacitor between the liquid insulation dielectric capacitor and the Moveable Object (either a Tape for Clamp functions or a Pull Electrode for Pull & Return functions). Appendix 1 develops the Force Equations needed to design Bladder systems that distribute electrostatic forces effectively across the three capacitors and Appendix 2 develops the Refresh Rate equations needed to neutralize charge leakage across the dielectric layers in each of the series capacitors. We will use the Force and Refresh Rate equations in our discussions on each of the two proposed configurations and invite the reader to Appendix 1 and Appendix 2 for more detail.

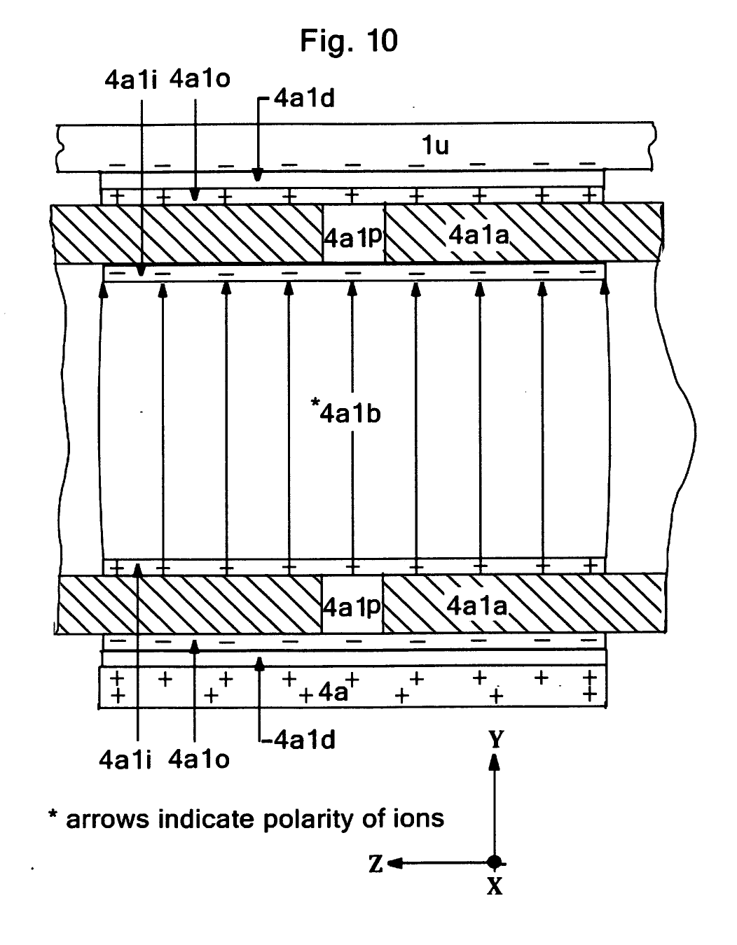

### 5. Internal Electrodes Configuration (FIG. 10)

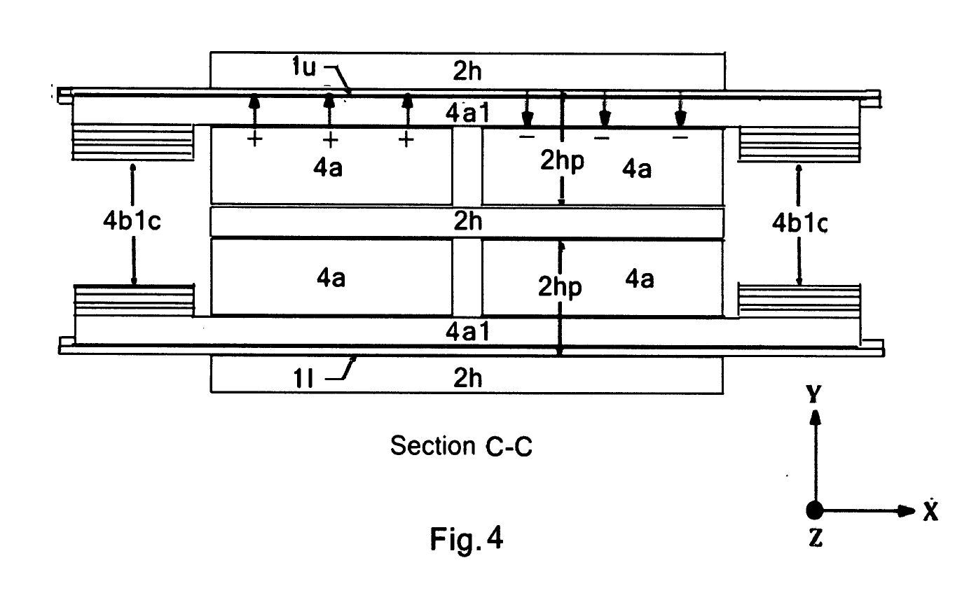

Liquid Dielectric Bladders with Internal Electrodes (FIGS. 4, 10, 11a,b,c,d) is the preferred configuration because the Electrodes can electrically by-pass the Bladder walls and their performance limiting effects to interface directly with the liquid dielectric insulator inside the Bladder walls. This, in turn, allows bladder wall material and thickness to be chosen based on considerations other than a high dielectric constant at no penalty in electrical performance, while the Electrode isolation insulating capacitors can be optimized for electrical performance. The discussion of this bladder type will begin with a description of its construction and function, continue by establishing the governing equations of its behavior and conclude with estimates of its performance.

a. Construction and Function

Construction is according to FIGS. 4, 10 and 11a,b,c,d wherein each bladder has an electrode system, a bladder structure and a gap inside the bladder, filled with liquid insulation dielectric. The electrode system has two electrode pairs as per FIG. 10, where each electrode pair has an electrode inside the bladder (4a1i) and an electrode outside the bladder (4a1o) with a conductor connecting the two electrodes (4a1p) that pierces the bladder insulation structure, while preventing the liquid insulation dielectric from leaking. The two Outer and Inner Electrode pairs are positioned on opposite sides of the liquid insulation dielectric gap inside the bladder structure. The Outer Electrodes are each coated by an insulating film (4a1d) with high dielectric constant, high resistivity, high dielectric strength and minimal thickness. The insulating film also provides a no load sliding surface for unclamped Moveable Object Tapes (1u in FIG. 10) when used in Clamp applications. In both Clamp and Drive applications, one Outer Electrode is in contact with the Drive Electrode (4a) while the other Outer Electrode is in contact with the Moveable Object to form three capacitors in series between the Drive Electrode and the Moveable Object.

b. Electrical Functions of the Bladder System

We begin with a general discussion on how the bladder system performs electrically. In FIG. 4, we see how positive electric charge generated on one Drive Electrode (4a) generates electric fields that go through the bladder (4a1) to the conductive Tape (1u) and return through another section of the same bladder to terminate on a second Drive Electrode with negative charge and in FIG. 12 we see how the bladder systems are positioned in the Tape Muscle clamp system. Bladder operation in more detail is also according to FIG. 10, where a Drive Electrode is charged and the charge is trapped on the Drive Electrode. This begins a near instantaneous series of events where the trapped charge induces a charge on the nearest Bladder Outer Electrode, followed by a charge being induced on its connected Bladder Inner Electrode, followed, in turn, by a charge being induced on the Bladder Inner Electrode across the Bladder liquid dielectric gap (4a1b), which in turn results in a charge being induced in the connected Bladder Outer Electrode nearest the Moveable Object Tape, which then results in a charge being induced on the Moveable Object Tape and sets up a series of electrostatic attractive forces which have the combined effect of forcing the Moveable Object Tape against the Wedge Contact Surfaces (2hw), with clamping as the result. Alternately the Moveable Object can be a Pull & Return Electrode (3h4) operating on a Pull & Return Flexure (3h2) and a pair of Motion Control Flexures (3h3) to drive a clamped Tape.

The series of electrostatic forces which provide the clamping (or drive) will now be described in more detail. The electrostatic attractive force between the Drive Electrode and the Electrode Coating Film on the surface of one Outer Electrode holds one side of the Bladder against Drive Electrode, where the Electrode Coating Films are high performance dielectric insulators. Electro-static attractive force between the Moveable Object and the Electrode Coating Film on the surface of the opposite Outer Electrode holds the opposite side of the Bladder against the Moveable Object. The electrostatic attractive force between Inner Electrodes pulls the opposite walls of the Bladder towards each other, forcing liquid out of the Gap and closing the Gap. While the Gap is closing, the Moveable Object is moving towards the Drive Electrode and performing useful work, either in clamping a Tape or in driving a clamped Tape. The Gap continues to close until the Moveable Object encounters a hard stop. In the Clamp application, the hard stop is provided by contact with the Wedge Contact Surfaces. In the Drive application the hard stop is a constructed Step Limiter. In both Clamp and Drive applications the electrostatic forces are amplified by high mechanical advantage small angle bending flexures. The connected Outer Electrode and Inner Electrode of each Electrode Pair act as a charge-neutral object where a charge induced on the Outer Electrode results in an equal and opposite charge on the connected Inner Electrode (and vice versa). The Electrode Coating Film on the surface of each of the Outer Electrodes and the Liquid Dielectric Insulator in the Bladder Gap each has a resistive component so charge induced on it will leak off over time. Thus, a periodic refresh is needed at a rate sufficient to offset leakage. The refresh rate is reasonable as will be shown in the more detailed discussions to follow.

c. Mechanical Functions of the Bladder System

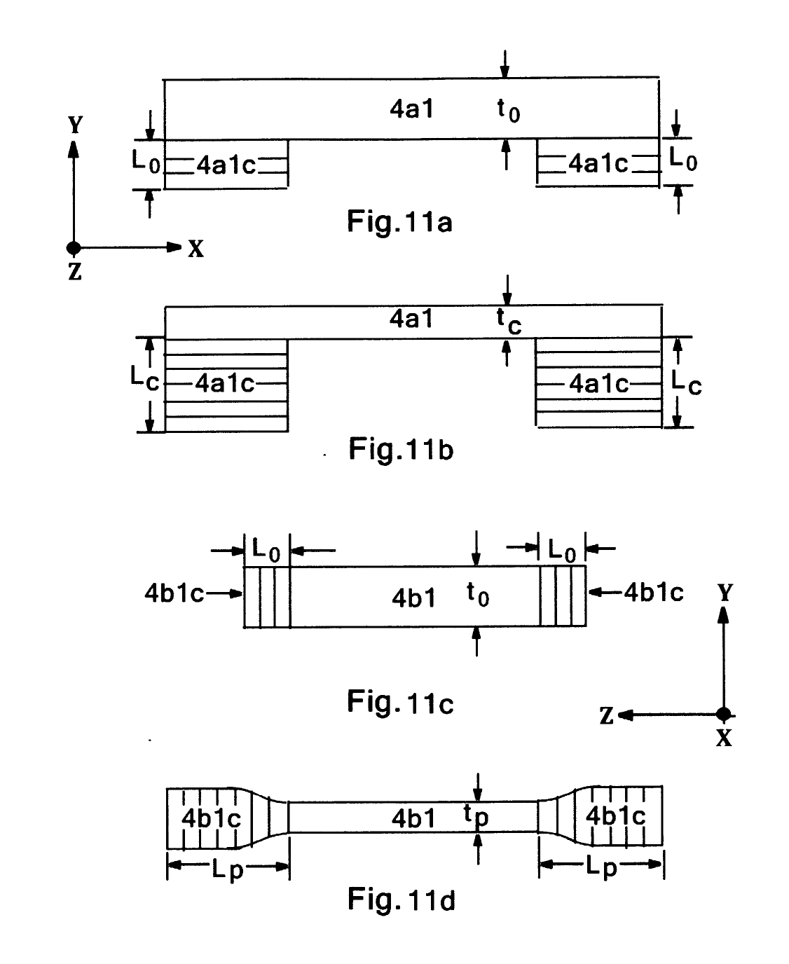

The bladder must perform several mechanical functions as well as the electrical functions described above. It must, first, contain the liquid dielectric insulator, with insignificant leakage. It must be able to deform under minimum force to allow the liquid to move, so the gap can be reduced and the Moveable Object can forcefully move to perform useful work (either Clamping Tape or Driving a Clamped Tape). It must have a spring constant so the bladder deformed under load can return to its original position to perform a repeat cycle, when the electrostatic forces are removed. The liquid is incompressible, but moves easily in shear, so the bladder must make room for the liquid displaced from the gap, either by stretching or bending using a bellows configuration (4a1c) (4b1c), according to FIGS. 11a and 11b or 11c and 11d. The Bladder walls must have strength sufficient to withstand the stresses and strains of repeated clamping and unclamping over extended periods of time and under challenging operational and weathering conditions. The Bladder walls must retain strength sufficient to perform their required function despite the inevitable degrading effects of chemical reactions with the liquid dielectric insulator. The Bladder walls, used in Clamp applications, must possess strength, wear factor and low coefficient of sliding friction sufficient to permit Tape repeatedly sliding against the Bladder walls, over extended periods of time, under no load conditions.

d. Chemical Functions of the Bladder System

The Bladder wall materials must be resistant to chemical reactions with the liquid dielectric insulation, both to inhibit the contamination and performance degradation of the liquid dielectric and to inhibit weakening and degradation of the bladder walls. With a liquid dielectric, freezing and boiling are also concerns along with electrical and chemical properties across the useful temperature range. But, materials can be chosen with minimal compromises for electrical requirements.

e. Preferred Materials

Our discussion on candidate materials will focus on the preferred bladder wall material and liquid dielectric insulator candidates.

Purified/Distilled or deionized Water is the preferred Liquid Insulating Dielectric. In circumstances where operations below freezing are required, deionized ethylene glycol/deionized water mixtures are the preferred Liquid Insulating Dielectric with electrical performance similar to purified water except intrinsic charge leak times are improved approximately an order of magnitude. Its properties of most interest are summarized below.

It has a dielectric constant of 80 at 25 deg C.,[11][12] with a resistivity of 182,000 ohm m at 25 deg C. [13] so its intrinsic charge leak times can be compensated at reasonable refresh rates. Deionized ethylene glycol/purified water mixtures can be used to operate below freezing, with dielectric constants on the same order as pure water, but with intrinsic time constants an order of magnitude greater. Dielectric strength remains high [14]. Teflon FEP Flurocarbon Film is the preferred material for the bladder walls. [15] It is chemically inert, mechanically tough against tear and easily manufactured into bags. It stretches. Metals can be easily plated on it. It holds fluids without significant seepage. It is transparent so fluid levels can be easily inspected. Has a low coefficient of friction. It is an electric insulator with very high resistivity and a low dielectric constant.

Electro less nickel is the material and process of choice for the inner and outer electrodes. The high phosphorous version is preferred because it is corrosive resistant and chemically inert. [16]

3-M C1011 Embedded Capacitance Material is the material of choice for the Film Covering the Outer Electrodes. [9] This is C₂ without copper covering on one side. That is, open ceramic dielectric makes contact with the Drive Electrode for one Outer Electrode and open ceramic dielectric makes contact with the Moveable Object Tape for the other Outer Electrode. Copper covering can remain on the side of the 3-M C1011 embedded capacitance material that is directly attached to the Outer Electrodes where the copper can provide mechanical support for the ceramic dielectric to prevent it from flaking off during no load sliding against the Tape. Young's Modulus is 1377 mega pascals=199717 psi (where steel has typically 30 E6 psi so Steel is 60 times stiffer than 3-M C1011. Young's Modulus for copper is given as 16 E6 psi so the value given by 3-M does represent the ceramic performance. A reasonable peel value is given and no coefficient of friction is given. Since we are sliding under no load, or at worst, minimum load conditions, these values will suffice. The electronic properties of 3-M C1011 are outstanding. It is thin, has a high dielectric constant and has high resistivity with low power dissipation. In our application 3-M C1011 stock material can be used and the copper removed from one surface before the copper clad surface is bonded to its Outer Electrode.

Alternately, Vespel SCD 5050 [17] can be used. It is has all the electrical properties of 3-M C1011 except its resistivity is much lower so it requires a higher refresh rate. This may turn out to be unimportant.

f. Governing Equations

The force equations are developed in Appendix 1 and the refresh rate equations are developed in Appendix 2. The reader is invited to visit Appendixes 1 and 2 and examine the rationale behind these equations. The equations apply equally to the INTERNAL ELECTRODES and the NO ELECTRODES configurations. In both configurations Charge Trapped on the Drive Electrode induces equal and opposite charge on the nearest grounded conductors, one of which is the grounded electrode of the Drive Electrode stack of capacitors and the other is the Tape. The Drive Electrode Charge apportions itself between the two parallel capacitor options according to their relative capacitances with a sizeable portion of the charge attracted to the Tape. The Tape responds to this electrostatic charge induction by moving towards the Drive Electrode and we get a useful work result. The Drive Electrode assumes a voltage consistent with the charge distribution and the parallel capacitances with the voltage drop across both paths the same. The voltage drop between Drive Electrode and Tape must cross a Bladder filled with a liquid dielectric insulator. This path across the Bladder involves three (3) capacitors in series. There is a capacitor with dielectric insulator between the Drive Electrode and the Bladder liquid dielectric insulator. There is a capacitor with liquid dielectric insulator across the liquid filled Gap in the Bladder and there is a capacitor with dielectric insulator between the liquid and the Tape. Voltage is dropped across each capacitor and electrostatic force is exerted across each. The electrostatic force across the capacitor between Drive Electrode and liquid holds the Bladder to the Drive Electrode. The electrostatic force between the liquid and the Tape holds the Tape to the Bladder and the electrostatic force across the liquid Gap pulls the walls of the Bladder together, taking the Tape as well, while the Drive Electrode structure reacts to the electrostatic forces. An electric flux path according to FIG. 4 but, a flux path in which the Tape is electrically grounded and a single Drive Electrode is used would work as well. Both configurations (INTERNAL ELECTRODES and NO ELECTRODES) use a Bladder with three capacitors in series. In the NO ELECTRODES configuration the Bladder walls and Bladder wall materials provide the insulation between Drive Electrode and liquid dielectric and between liquid dielectric and Tape. In the INTERNAL ELECTRODE configuration the internal electrodes bypass the Bladder walls and an insulation dielectric is added to the outer portion of each Internal Electrode structure to provide the electrical insulation and electrostatic capacitive forces between the Drive Electrode and the Bladder and between the Bladder and the Tape. So, the equations apply to both cases with results that reflect the different approaches required in the materials and thickness used in the isolation capacitances between Drive Electrode and liquid insulator dielectric and between liquid insulator dielectric and Tape.

The force \vec{F}_{L} across the liquid insulation dielectric capacitor is determined by eq (26) from Appendix 1.
The force \vec{F}_{W} across the isolation capacitors is determined by eq (27) from Appendix 1.

$$\begin{matrix}{\vec{F}}_{L} = {V}_{S}^{2} \cdot {C}_{2} \cdot \frac{{( \frac{{K}_{W} \cdot {K}_{L}}{{K}_{W} + {K}_{L}} + 1 )}^{2}}{{( \frac{{K}_{W} \cdot {K}_{L} \cdot {X}_{0}}{{K}_{W} \cdot X + {K}_{L} \cdot {X}_{0}} + \frac{1}{n} )}^{2}} \cdot \frac{{( {K}_{W} )}^{2} \cdot ( {K}_{L} \cdot {X}_{0} )}{{( {K}_{W} \cdot X + {K}_{L} \cdot {X}_{0} )}^{2}} \cdot 39.37 \frac{in}{m} newtons & eq ( 26 ) \\ {\vec{F}}_{W} = {\vec{F}}_{L} \cdot ( \frac{X}{W} ) \cdot ( \frac{{K}_{W} \cdot X}{{K}_{L} \cdot {X}_{0}} ) newtons & eq ( 27 )\end{matrix}$$

Equation (26) and eq (27) apply where the complete electric flux path passes through two C_{X} capacitors and when X and X₀ are in inches)
The constants are evaluated in two steps. We first compare two same area capacitors, a base capacitor C₂ and a second capacitor (say C_{W}).

$$\frac{{C}_{W}}{{C}_{2}} = {K}_{W} ( a constant )$$

$$\frac{\frac{{ɛ}_{RK}}{{d}_{w}}}{\frac{{ɛ}_{R 2}}{{d}_{2}}} = \frac{{ɛ}_{RW} {d}_{2}}{{ɛ}_{R 2} {d}_{W}} = {K}_{W} ( where area of {C}_{2} = area of {C}_{W} )$$

(We note K_{w} is the combined effect of both isolation capacitors in the series of three (3) capacitors and it implies that the two isolation capacitors are equal and the voltage drops, forces and fields across them are also equal. This is typically the case. Where it is not, the overall K_{W} can be calculated as per eq (26) and eq (27) and the effects for each isolation capacitor can then be determined from the overall results. This is straightforward and will be left to the reader.)

### Similarly:

$$\frac{{ɛ}_{RL} {d}_{2}}{{ɛ}_{R 2} {d}_{L}} = {K}_{L}$$

(where area of C₂=area of C_{L})

### Thus:

C_{L}=K_{L}C₂ and C_{W}=K_{W}C₂ (where C_{W} is combined capacitance of the bladder walls)

### And:

$${C}_{L} \frac{{X}_{0}}{X} = {K}_{L} {C}_{2} \frac{{X}_{0}}{X}$$

(capacitance across liquid thickness X inside bladder relative to X₀)

### Or:

C_{L}=K_{L}C₂ (capacitance across liquid thickness inside bladder where X=X₀)

### Where:

$${C}_{2} = \frac{8.854 \cdot {10}^{- 12} \frac{farads}{m} \cdot 20 \cdot 2 in \cdot 1 in}{0.00043 in \cdot 39.37 \frac{in}{m}} = 2.0920190677591 \cdot {10}^{- 8} farads \qquad [ 9 ]$$

g. Estimated Force Performance

$$F = {V}_{S}^{2} \cdot {C}_{2} \cdot \frac{{( \frac{{K}_{W} {K}_{L}}{{K}_{L} + {K}_{W}} + 1 )}^{2}}{{( \frac{{K}_{W} {K}_{L} {X}_{0}}{{K}_{L} {X}_{0} + {K}_{W} X} + \frac{1}{n} )}^{2}} \cdot \frac{{{K}_{W}}^{2} {K}_{L} {X}_{0}}{{( {K}_{L} {X}_{0} + {K}_{W} X )}^{2}} \cdot 39.37 \frac{in}{m} newtons \qquad ( 13 )$$

1). For X=0.020 in

$${K}_{W} = 0.5 \\ {K}_{L} = 0.086 ( X = {X}_{0} = 0.020 in \} \\ n = 50 , {C}_{2} = 2.0920190677591 \cdot {10}^{- 8} farads \\ F = {V}_{S}^{2} \cdot {C}_{2} \cdot \frac{{( \frac{0.5 \cdot 0.086}{0.086 + 0.5} + 1 )}^{2}}{{( \frac{0.5 \cdot 0.086 \cdot 0.020}{0.086 \cdot 0.020 + 0.5 \cdot 0.020} + \frac{1}{50} )}^{2}} \cdot \frac{{0.5}^{2} \cdot 0.086 \cdot 0.020}{{( 0.086 \cdot 0.020 + 0.5 \cdot 0.020 )}^{2}} \cdot 39.37 \frac{in}{m} ( newtons ) \\ F = {V}_{S}^{2} \cdot 0.0003406853033 newtons \\ {V}_{S} = 100 volts \\ F = 3.406853033 newtons = 0.7658909634007 lbf \\ {F}_{C} = \frac{F}{sin ( 5 )} \cdot {μ}_{S} = 6.1513293040566 lbf , {μ}_{S} = 0.7 \\ {V}_{S} = 400 volts \\ F = 54.509648528 newtons = 12.25425541 lbf \\ {F}_{C} = \frac{F}{sin ( 5 )} \cdot {μ}_{S} = 98.42126886 lbf \\ {F}_{D} = F \cdot \frac{sin ( 5 )}{2 ( 1 - cos ( 5 ) )} = 140.33429644 lbf \qquad ( 13 )$$

2). For X=0.010 in

$$F = {V}_{S}^{2} \cdot {C}_{2} \cdot \frac{{( \frac{0.5 \cdot 0.086}{0.086 + 0.5} + 1 )}^{2}}{{( \frac{0.5 \cdot 0.086 \cdot 0.020}{0.086 \cdot 0.020 + 0.5 \cdot 0.010} + \frac{1}{50} )}^{2}} \cdot \frac{{0.5}^{2} \cdot 0.086 \cdot 0.020}{{( 0.086 \cdot 0.020 + 0.5 \cdot 0.010 )}^{2}} \cdot 39.37 \frac{in}{m} ( newtons ) \\ F = {V}_{S}^{2} \cdot 0.000412651413 newtons \\ {V}_{S} = 100 volts \\ \begin{matrix}F = 4.12651413 newtons \\ = 0.9276772000138 lbf ( too small )\end{matrix} \\ {V}_{S} = 400 volts \\ F = 66.02422608 newtons = 14.84283520 lbf \\ {F}_{C} = \frac{F}{sin ( 5 )} \cdot {μ}_{S} = 119.21170439 lbf , \\ {μ}_{S} = 0.7 \\ {F}_{D} = F \cdot \frac{sin ( 5 )}{2 ( 1 - cos ( 5 ) )} = 169.97840875 lbf \qquad ( 13 )$$

h. Estimated Refresh Rate

$$\begin{matrix}{f}_{Ref} \geq \frac{1}{{τ}_{Sys}} = \frac{1}{{τ}_{Gap}} + \frac{1}{{τ}_{Stk}} \\ Where \text{:} {τ}_{Gap} = {R}_{Gap} {C}_{Gap} and \\ {τ}_{Stk} = {R}_{Stk} {C}_{Stk} & eq ( 1 ) \\ {C}_{Gap} = \frac{{K}_{L} {X}_{0 } {K}_{W}}{{K}_{L} {X}_{0} + {K}_{W} X} {C}_{2} and \\ {C}_{Stk} = \frac{{C}_{2}}{n} & ( From Appendix 2 eq ( 4 ) )\end{matrix}$$

### Where:

R_{Gap}=R_{L}+R_{W} and R_{Stk}=nR_{C2} (From Appendix 2 eq (7))

Where: (From Appendix 2 between eq (13) and eq (14))

ρ_{C1011}=2.32558139534·10¹¹ ohm−in

ρ_{water}=182,000 ohm−m=7165340 ohm−in at 25 deg C. [13]

Which leads to:

$${R}_{Gap} = {ρ}_{C 1011} \frac{{W}_{C 1011}}{A} + {ρ}_{water} \frac{X}{{X}_{0} A} \\ {τ}_{Gap} = ( {ρ}_{C 1011} \frac{{W}_{C 1011}}{A} + {ρ}_{water} \frac{X}{{X}_{0} A} ) ( \frac{{K}_{L} {X}_{0 } {K}_{W}}{{K}_{L} {X}_{0} + {K}_{W} X} ) {C}_{2} \\ {τ}_{Stk} = n {R}_{C 2} \frac{{C}_{2}}{n} = {R}_{C 2} {C}_{2} sec \\ Where {R}_{C 2} = {ρ}_{C 1011} \frac{{W}_{C 1011}}{2 A} \qquad ( From Appendix 2 eq ( 14 ) )$$

### And:

$${f}_{Ref} \geq \frac{1}{{τ}_{Sys}} = \frac{1}{{τ}_{Gap}} + \frac{1}{{τ}_{Stk}}$$

1). For X=0.020 in

$${K}_{W} = 0.5$$

$${K}_{L} = 0.086 ( X = {X}_{0} = 0.020 in \}$$

$$n = 50 , {C}_{2} = 2.0920190677591 \cdot {10}^{- 8} farads$$

$${τ}_{Gap} = ( 2.32558139534 \cdot {10}^{11} \cdot \frac{0.00086}{2} + 7165340 \cdot \frac{1}{2} ) \cdot ( \frac{0.086 \cdot 0.020 \cdot 0.5}{0.086 \cdot 0.020 + 0.5 \cdot 0.020} ) \cdot 2.0920190677591 \cdot {10}^{- 8} sec$$

$${τ}_{Gap} = 0.1590096858589 sec$$

$$\begin{matrix}{τ}_{Stk} = 2.32558139534 \cdot {10}^{11} \cdot \frac{0.00086}{4} \cdot 2.0920190677591 \cdot {10}^{- 8} \\ = 1.04600954 sec\end{matrix}$$

$${f}_{REF} \geq \frac{1}{0.1590096858589 sec} + \frac{1}{1.04600954 sec} = 7.24493930 \frac{cycles}{sec}$$

2). For X=0.010 in

$${K}_{W} = 0.5$$

$${K}_{L} = 0.086 ( X = 0.010 in , {X}_{0} = 0.020 in \}$$

$$n = 50 , {C}_{2} = 2.0920190677591 \cdot {10}^{- 8} farads$$

$${τ}_{Gap} = ( {ρ}_{C 1011} \frac{{W}_{C 1011}}{A} + {ρ}_{water} \frac{X}{{X}_{0} A} ) ( \frac{{K}_{L} {X}_{0 } {K}_{W}}{{K}_{L} {X}_{0} + {K}_{W} X} ) {C}_{2}$$

$${τ}_{Gap} = ( 2.32558139534 \cdot {10}^{11} \cdot \frac{0.00086}{4} + 7165340 \cdot \frac{1}{4} ) \cdot ( \frac{0.086 \cdot 0.020 \cdot 0.5}{0.086 \cdot 0.020 + 0.5 \cdot 0.020} ) {C}_{2}$$

$${τ}_{Gap} = 0.13866023 sec$$

$$\begin{matrix}{τ}_{Stk} = 2.32558139534 \cdot {10}^{11} \cdot \frac{0.00086}{4} \cdot 2.0920190677591 \cdot {10}^{- 8} \\ = 1.04600954 sec\end{matrix}$$

$${f}_{REF} \geq \frac{1}{0.13866023 sec} + \frac{1}{1.04600954 sec} = 8.16788745 \frac{cycles}{sec}$$

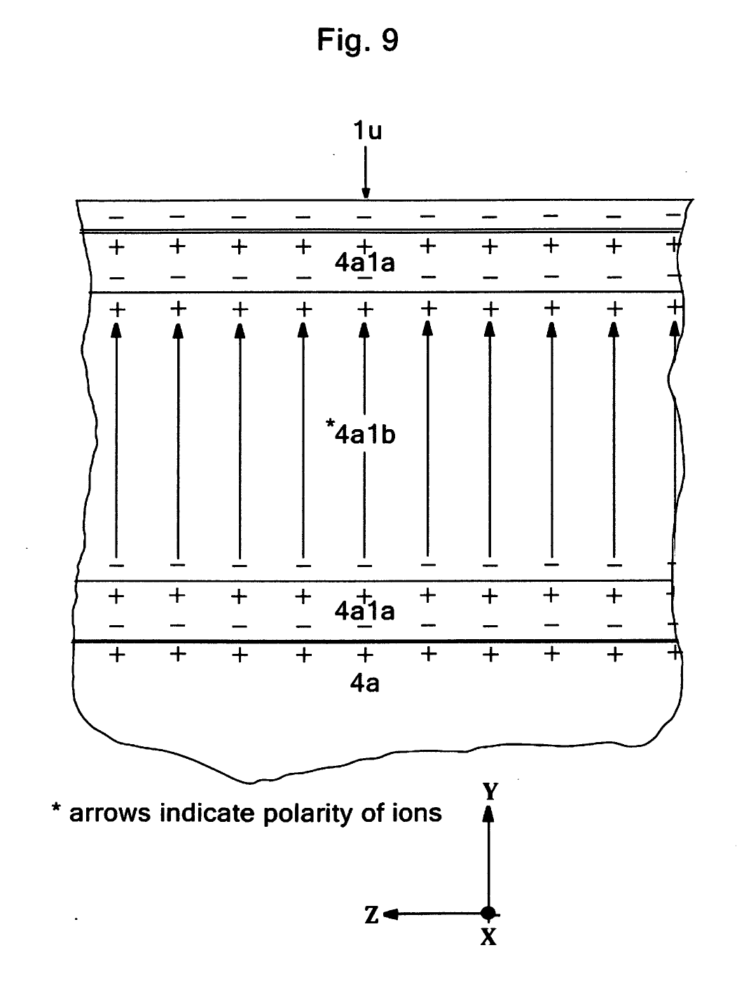

### 6. No Electrodes Configuration (FIG. 9)

Liquid Dielectric Bladders with no conductive electrodes are the simplest bladder configuration but, require the bladder walls to perform the function of isolation capacitor between the Drive Electrode and the liquid dielectric on one side of the Bladder and to perform the function of isolation capacitor between the liquid dielectric and the Moveable Object (Tape or Pull Flexure electrode) on the other in addition to their other roles of: 1. Containment and management of the movement of the liquid dielectric insulator within the bladder, 2. A spring to return the Moveable Object to its rest position when the electrical field is off and position it for another cycle and 3. Provide a no load sliding wear surface for the Tape when used in the Clamp application, 3. A mechanical structure sufficiently strong to withstand the wear and tear of heavy use over extended time, 4. A structure that resists chemical reactions with the liquid dielectric within so as to maintain the performance level of the liquid dielectric and prevent and delay weakening of the bladder walls over extended periods of time. The discussion of this bladder type will begin with a description of its construction and function, continue by establishing the governing equations of its behavior and conclude with estimates of its performance.

a. Construction and Function

Construction of a bladder without electrodes is according to FIGS. 2, 3, 4, 11a and 11b) and it functions electrically according to FIGS. 4 and 9. It performs mechanically according to FIGS. 11a and 11b using bladder wall material that is chemically and structurally resistive to the liquid dielectric insulator within the bladder and to the effects of weather and the operational environment outside the bladder. We will now discuss each of these subjects in more detail starting with electrical performance.

b. Electrical Functions of the Bladder System

We begin with a general description on how the bladder system performs electrically. In FIG. 4, we see how positive electric charge generated on one Drive Electrode generates electric fields that go through the bladder to the conductive Tape and return through another section of the same bladder to terminate on a second Drive Electrode with negative charge. In FIG. 9 we see how the electric fields generate forces of attraction in both legs of the flux path that pull the Tape against the Clamp Wedge structure using a series of electrostatic attractive forces, whereby the outer surface of the bladder wall is held against the Drive Electrode, the outer surface of the bladder on the opposite side is held against the Tape, while the inner surfaces of the bladder walls are attracted and pulled towards each other. As a result of this combination of forces, the bladder walls move towards each other, taking the Tape with it, while the bladder remains anchored to the Drive Electrode load bearing structure. This movement continues until the Tape is stopped by contact with the Wedge Contact Surfaces of the Clamp & Hold structure and the Tape is clamped to the Wedge Contact Surfaces. When the Charge on the Drive Electrode is removed, the electric fields collapse in the bladder walls and the liquid dielectric insulator and the induced electrostatic forces collapse with them. At this point the bladder returns to its rest configuration and the Tape is removed from the Wedge Contact Surfaces and is available for no load sliding over the bladder surface. FIGS. 4 and 9 show an example of one polarity used to energize the electrostatic forces. The opposite polarity can be employed as well. In both cases the Tape is clamped against the Wedge Contact Surfaces. All the dielectric insulators have resistivity so the induced charges will leak off and a refresh rate is needed to compensate. So, the RC constants for each structure must be factored into material selection and determining refresh rate. FIG. 9 shows that the electric circuit from Drive Electrode to Tape is, in effect, three capacitors in series, two using bladder wall material as a dielectric insulator and one using liquid as a dielectric insulator. Similarly, the electric flux path from Tape to Drive Electrode uses the same three capacitors in series with opposite charge polarity. The bladder walls prefer as large a capacitance per unit area as possible so a thin wall with high dielectric constant, high dielectric strength and high resistivity is desired. The liquid dielectric also prefers as large a capacitance per unit area as possible, but requires thickness sufficient to permit the Tape to engage and disengage from the Wedge Clamping Surfaces. The liquid dielectric also prefers a high dielectric constant, a high dielectric strength and high resistivity. Freezing and boiling points are also important as well as electrical performance at temperatures in between. (The above discussion focuses on the Clamp application where a conductive Tape is the Moveable Object but, is also applicable to the Drive application where the Pull & Return Electrode is the Moveable Object.)

c. Mechanical Functions of the Bladder System

The bladder must perform several mechanical functions as well as the electrical functions described above. It must, first, contain the liquid dielectric insulator, with insignificant leakage, while satisfying the electrical requirements that the walls be as thin as possible. It must be able to deform under minimum force to allow the liquid to move, so the gap can be reduced and the Tape can move to engage the Wedge Clamping Surfaces. It must have a spring constant so the bladder deformed under load can return to original position and disengage the Tape from the Wedge Clamping Surfaces, when the electrostatic forces are removed. The liquid is incompressible, but moves easily in shear, so the bladder must make room for the liquid displaced from the gap, either by stretching or bending using a bellows configuration, according to FIGS. 11a and 11b or 11c and 11d. The bladder walls, made thin to satisfy electrical requirements, must maintain strength sufficient to withstand the stresses and strains of repeated clamping and unclamping over extended periods of time and under challenging operational and weathering conditions. The bladder walls must retain strength sufficient to perform their required function despite the inevitable degrading effects of chemical reactions with the liquid dielectric insulator. The bladder walls must possess strength, wear factor and low coefficient of sliding friction sufficient to permit Tape repeatedly sliding against the bladder walls, over extended periods of time, under no load conditions.

d. Chemical Functions of the Bladder System

The bladder wall materials must be resistant to chemical reactions with the liquid dielectric insulation, both to inhibit the contamination and performance degradation of the liquid dielectric and to inhibit weakening and degradation of the bladder walls. With a liquid dielectric freezing and boiling are also concerns along with electrical and chemical properties across the useful temperature range.

e. Preferred Materials

Our discussion on candidate materials will focus on the preferred bladder wall material and liquid dielectric insulator candidates.

Vespel SCP5050 polyimide direct formed parts is the preferred candidate for bladder walls.[17] [ref Vespe] Its properties of most interest are summarized below.

Tensile Strength (11.5 ksi @23 deg C., 6 ksi @ 260 deg C.):Relative Dielectric Constant (21.1 @ 100 hz, 20.6 @ 10 khz, 19.1 @ 1 mhz): Dielectric Strength (Not given because Vespel SC5050 is considered conductive enough to prevent voltage breakdown, but resistive enough to hold charge long enough for capacitance power transfer using refresh):Volume Resistivity [SCP 5050 ref](3.7 E7 ohm-in =932 kilo ohm meters @ 25 deg C.):Chemical Resistivity [ref Properties of DuPont Vespel Parts, p. 20 Chemical Effects] Table 3 shows problems with acids and bases, but is not materially affected by water except at extremely high boiling point temperatures. As explained in the text on page 20, along side Table 3, SP polyimide parts (Vespel) are not affected by water, or other aqueous media, except at extremely high temperatures near boiling 212 deg F. Its water absorption is 0.07% by weight [ref SCP 5050] and its mechanical properties are minimally affected except at extremely high temperatures near boiling 212 deg F. Purified/Distilled or deionized Water is the preferred Liquid Insulating Dielectric. In circumstances where operations below freezing are required, deionized ethylene glycolldeionized water mixtures are the preferred Liquid Insulating Dielectric with electrical performance similar to purified water except intrinsic charge leak times are improved approximately an order of magnitude. Its properties of most interest are summarized below.

It has a dielectric constant of 80 at 25 deg C., with a resistivity of 182,000 ohm m at 25 deg C. [ref Wikipedia Properties of water] so its intrinsic charge leak times can be compensated at reasonable refresh rates. Deionized ethylene glycol/purified water mixtures can be used to operate below freezing, with dielectric constants on the same order as pure water, but with intrinsic time constants an order of magnitude greater. Dielectric strength remains high.[ref. Pulsed high-voltage dielectric properties of ethylene glycol/water mixtures, David B. Fenneman, Naval Surface Weapons Center Dahlgren, Va., 22448, published in 8961 J. Applied Phys. 53(12), December 1982.]

f. Governing Equations

The force equations are developed in Appendix 1 and the refresh rate equations are developed in Appendix 2. The reader is invited to visit Appendixes 1 and 2 and examine the rationale behind these equations. The equations apply equally to the INTERNAL ELECTRODES and the NO ELECTRODES configurations and the reader is invited to the explanation in the INTERNAL ELECTRODES CONFIGURATION discussion for a more detailed explanation.

The force \vec{F}_{L} across the liquid insulation dielectric capacitor is determined by eq (26) from Appendix 1.

The force \vec{F}_{W} across the isolation capacitors is determined by eq (27) from Appendix 1.

$$\begin{matrix}{\vec{F}}_{L} = {V}_{S}^{2} \cdot {C}_{2} \cdot \frac{{( \frac{{K}_{W} \cdot {K}_{L}}{{K}_{W} + {K}_{L}} + 1 )}^{2}}{{( \frac{{K}_{W} \cdot {K}_{L } \cdot {X}_{0}}{{K}_{W} \cdot X + {K}_{L} \cdot {X}_{0}} + \frac{1}{n} )}^{2}} \cdot \frac{{( {K}_{W} )}^{2} \cdot ( {K}_{L} \cdot {X}_{0 } )}{{( {K}_{W} \cdot X + {K}_{L} \cdot {X}_{0} )}^{2}} \cdot 39.37 \frac{in}{m} newtons & eq ( 26 ) \\ {\vec{F}}_{W} = {\vec{F}}_{L} \cdot ( \frac{X}{W} ) \cdot ( \frac{{K}_{W} \cdot X}{{K}_{L} \cdot {X}_{0}} ) & eq ( 27 )\end{matrix}$$

(Equation (13) is two times equation (12) and applies where the complete electric flux path passes through two C_{X} capacitors which multiply the force by two. Equations (12) and (13) apply when X and X₀ are in inches)

We now determine K_{L} and K_{W} using methods as per Appendix 1 with Vespel SCP 5050 as our material with wall thickness of 0.002 in for each wall (0.004 in total isolation capacitor thickness because we judge this to be the minimum thickness that will support the mechanical requirements of the Bladder structure.) We use X₀=0.020 in as the maximum liquid dielectric Gap and X as any liquid dielectric Gap less than maximum and n=50 as the number of C₂. capacitors in the Drive electrode stack of capacitors. We use 3-M C1011 embedded capacitor material for our stack of capacitors and 2 in² as the area for our capacitors. These values are shared with the previously described INTERNAL ELECTRODES CONFIGURATION.

$${K}_{L} = 0.086 ( unchanged from Internal Electrodes Configuration )$$

$${K}_{W} = 0.1075 ( from {K}_{W} = \frac{0.00043 \cdot 20}{0.004 \cdot 20} )$$

We will now continue on to estimating force performance before returning to the subject of refresh rates.
g. Estimated Force Performance

For estimating forces we return to eq (26) and eq (27) from Appendix 1 and substitute in the design parameters (K_{L}, K_{W}, X₀ and n) that apply to our proposed system. We are concerned that \vec{F}_{L} be sufficiently strong to perform the functions of Clamp and Pull & Return and we are concerned that \vec{F}_{W}≧\vec{F}_{L} so the Moveable Object is brought along with the Bladder walls as they come together with force \vec{F}_{L}.

$$\begin{matrix}{\vec{F}}_{L} = {V}_{S}^{2} \cdot {C}_{2} \cdot \frac{{( \frac{0.1075 \cdot 0.086}{0.1075 + 0.086} + 1 )}^{2}}{{( \frac{0.1075 \cdot 0.086 \cdot 0.020}{0.1075 \cdot X + 0.086 \cdot 0.020} + 0.020 )}^{2}} \cdot \frac{{( 0.1075 )}^{2} \cdot ( 0.086 \cdot 0.020 )}{{( 0.1075 \cdot X + 0.086 \cdot 0.020 )}^{2}} \cdot 39.37 \frac{in}{m} newtons & modified eq ( 26 ) \\ {\vec{F}}_{W} = {\vec{F}}_{L} \cdot ( \frac{X}{0.004} ) \cdot ( \frac{0.1075 \cdot X}{0.086 \cdot 0.020} ) & modified eq ( 27 )\end{matrix}$$

1). Forces in the case where X=X₀=0.020 in

$${\vec{F}}_{L} = {V}_{S}^{2} \cdot 0.000261227091 newtons$$

$${V}_{S} = 100 Volts$$

$${\vec{F}}_{L} = 2.61227091 newtons ( too small )$$

$${V}_{S} = 400 Volts$$

$${\vec{F}}_{L} = 41.79633456 newtons = 9.39618899 lbf$$

$${\vec{F}}_{W} = {\vec{F}}_{L} \cdot 6.25 ( OK )$$

$${F}_{C} = \frac{F}{sin ( 5 )} \cdot {μ}_{S} = 75.46642465 lbf , \\ {μ}_{S} = 0.7$$

$${F}_{D} = F \cdot \frac{sin ( 5 )}{2 ( 1 - cos ( 5 ) )} = 107.604055 lbf$$

2). Forces in the case where X=0.010 in X₀=0.020 in

$${\vec{F}}_{L} = {V}_{S}^{2} \cdot 0.0003099572722$$

$${V}_{S} = 100 Volts$$

$${\vec{F}}_{L} = 3.099572722 newtons ( too small )$$

$${V}_{S} = 400 Volts$$

$${\vec{F}}_{L} = 49.59316355 newtons = 11.14898572 lbf$$

$${\vec{F}}_{W} = {\vec{F}}_{L} \cdot 1.5625 ( OK )$$

$${F}_{C} = \frac{F}{sin ( 5 )} \cdot {μ}_{S} = 89.54418558 lbf , \\ {μ}_{S} = 0.7$$

$${F}_{D} = F \cdot \frac{sin ( 5 )}{2 ( 1 - cos ( 5 ) )} = 127.67687752 lbf$$

h. Estimated Refresh Rates

We now return to determine the required minimum refresh rates to counter charge leakage through the resistance inherent in capacitor dielectric insulators.

1). Governing Equations

### From Appendix 2:

$$\begin{matrix}{f}_{Ref} \geq \frac{1}{{τ}_{Sys}} = \frac{1}{{τ}_{Gap}} + \frac{1}{{τ}_{Stk}} \\ Where \text{:} {τ}_{Gap} = {R}_{Gap} {C}_{Gap} and \\ {τ}_{Stk} = {R}_{Stk} {C}_{Stk} & eq ( 1 ) \\ {C}_{Gap} = \frac{{K}_{L} {X}_{0 } {K}_{W}}{{K}_{L} {X}_{0} + {K}_{W} X} {C}_{2} and & eq ( 4 ) \\ {R}_{Gap} = {ρ}_{Vespel} \frac{{W}_{Vespel}}{A} + {ρ}_{water} \frac{X}{{X}_{0} A} \\ \begin{matrix}{ρ}_{water} = 182 , 000 ohm - m \\ = 7165340 ohm - in at 25 deg C . [ ref ]\end{matrix} & eq ( 15 ) \\ {ρ}_{Vesp} = 3.7 \cdot {10}^{7} ohm - in & [ 17 ]\end{matrix}$$

We now determine C_{Gap}, R_{Gap} and τ_{Gap}.
We know:

$$\begin{matrix}{C}_{Gap} = \frac{0.086 \cdot {X}_{0} \cdot 0.1075}{0.086 \cdot {X}_{0} + 0.1075 \cdot X} {C}_{2} & eq ( 4 ) \\ {R}_{Gap} = 3.7 \cdot {10}^{7} \cdot \frac{0.004}{2} + 7165340 \cdot \frac{X}{2 {X}_{0}} \\ {τ}_{Stk} = 1.04600954 sec & eq ( 15 )\end{matrix}$$

2). For X=X₀=0.020 in:

$$\begin{matrix}{C}_{Gap} = \frac{{K}_{L} {X}_{0 } {K}_{W}}{{K}_{L} {X}_{0} + {K}_{W} X} {C}_{2} & eq ( 4 ) \\ \begin{matrix}{C}_{Gap} = \frac{0.086 \cdot 0.020 \cdot 0.1075}{0.086 \cdot 0.020 + 0.1075 \cdot 0.020} {C}_{2} \\ = 9.99520221 \cdot {10}^{- 10} coulombs\end{matrix} & eq ( 4 ) \\ {R}_{Gap} = 3.7 \cdot {10}^{7} \cdot \frac{0.004}{2} + 7165340 \cdot 0.5 = 3656670 ohms & eq ( 15 ) \\ {R}_{Gap} = 3.7 \cdot {10}^{7} \cdot \frac{0.004}{2} + 7165340 \cdot \frac{X}{2 {X}_{0}} \\ {τ}_{Gap} = 0.0036549156075 sec & eq ( 16 )\end{matrix}$$

From previous discussions in INTERNAL ELECTRODES CONFIGURATION:

$${τ}_{Stk} = 1.04600954 sec$$

$${f}_{Ref} \geq \frac{1}{0.0036549156 sec} + \frac{1}{1.04600954 sec} = 274.56014342 \frac{cycles}{sec}$$

3). For X=0.010 in, X₀=0.020 in

$$\begin{matrix}{C}_{Gap} = \frac{0.086 \cdot 0.020 \cdot 0.1075}{0.086 \cdot 0.020 + 0.1075 \cdot 0.010} {C}_{2} = 1.38395108 \cdot {10}^{- 9} Coulombs & eq ( 4 ) \\ {R}_{Gap} = 3.7 \cdot {10}^{7} \cdot \frac{0.004}{2} + 7165340 \cdot \frac{0.010}{2 \cdot 0.020} = 1865335 ohms & eq ( 17 ) \\ \begin{matrix} {τ}_{Gap} = 1865335 ohms \cdot 1.38395108 \cdot {10}^{- 9} Coulombs \\ = 0.0025815323878 sec\end{matrix} & eq ( 18 ) \\ {τ}_{Stk} = 1.04600954 sec \\ {f}_{Ref} \geq \frac{1}{0.0025815324 sec} + \frac{1}{1.04600954 sec} = 388.32283741 \frac{cycles}{sec} & eq ( 19 )\end{matrix}$$

### C. SUMMARY OF TAPE MUSCLE PROPERTIES

TABLE I
PERFORMANCE SUMMARY

Speed: 6.4378082315 in/sec Tape Speed, using a 5 khz Drive Cycle
and a 0.0012687560463 in step size. Each Drive Cycle requires 6 steps
and each Charge Step requires 3 steps, for a required microcontroller
clock speed of 90 khz. Tape Speed is adequate for fast reaction
applications and the clock speed is well within available art. Higher Tape
Speed with a higher microprocessor clock speed is available using
present art.
V_{S} = 400 Volts for Clamping and Drive Force values.
Clamping Force:
98.42126886 lbf minimum INTERNAL ELECTRODES
CONFIGURATION
75.46642465 lbf minimum NO ELECTRODES CONFIGURATION
Drive Force:
140.33429644 lbf minimum INTERNAL ELECTRODES
CONFIGURATION
107.604055 lbf minimum NO ELECTRODES CONFIGURATION
Refresh Rate:
8.16788745 cycles/sec minimum INTERNAL ELECTRODES
CONFIGURATION
388.32283741 cycles/sec minimum NO ELECTRODES
CONFIGURATION
Actuators: 4 actuators or appendages can be moved in a 2 directions,
with Tape using tension to oppose the load.

### 3. Conclusions on Bladder and Charge-Driven Electrostatic Induction Combinations

a. Charge-Driven Electrostatic Induction can provide adequate power to Clamp and Drive a Tape Muscle and can be packaged inside the Clamp and Clamp & Drive modules. Performances of 100 lbf and tape speeds in excess of 6 in/sec seem easily achievable.
b. A Bladder, filled, with a high dielectric strength, high dielectric constant liquid insulator, in which the bladder walls are strong, thin and flexible, with high dielectric strength and a high dielectric constant provide a satisfactory means to induce large electrostatic charges and avoid air breakdown. Distilled water seems a good liquid dielectric insulator and Kapton, with bellows expansion geometry, seems a good material for the bellows walls.
c. The liquid filled bladder also performs spring functions in positioning the Tape away from Clamp contact when a Clamp module is discharged and in returning a Drive module flexure to rest when a Drive module is discharged.
d. Distilled water can only work between 0° C. and 100° C. For a Tape Muscle using distilled water to operate beyond the freezing to boiling temperature limits, heating or cooling must be provided. Distilled water loses its dielectric and insulation properties over time because of chemical interaction with the Kapton. So, bladders will have to be periodically replaced.
e. There is the possibility of using another liquid, such as ethanol, to allow subfreezing operations and there are surface coatings that can be applied to Kapton, like vapor deposited tin, to extend the electrical life of the distilled water.

### C. Tape Muscle Form, Fit, Function and Performance

We will now combine and consolidate the discussions of III.A and III.B to provide an overall view of the Tape Muscle concept and its capabilities. We will do so by describing a preferred embodiment with some options to provide flexibility.

TABLE II
TAPE MUSCLE SIZE

(1 Clamp module and 1 Clamp & Drive module in Series with 4
Tape Loop Configuration)
Length: 4.45 in (overall), (Clamp module 2.1625 in + Clamp &
Drive module 2.1625 in +, (separation between modules 0.125 in).
The length at the end of the Clamp & Hold Module required to turn
the Tapes around is neglected.
Width: 2.0625 in (Clamp module), 2.5625 in (Clamp & Drive module).
(Clamp & Drive module width is 2.0625 in + 0.25 in motion control
flexures on each side.)
Height: 1.411 in (Clamp module), 1.783 in (Clamp & Drive module)
(Clamp & Drive module height based on Clamp module height + 0.186
in Pull & Return module top and bottom.)
(*Height based on Charge-Driven Electrostatic Induction stack size n =
100 in Clamp Module and n = 50 in each of 2 Drive Modules.)
Weight: 2.4867 lb (overall), (Clamp module 0.9676 lb), (Clamp & Drive
module 1.5191 lb). (Clamp module), 2.677 lb (Clamp & Drive module)
(*Overall weight is estimated as the weight of the Clamp Module + the
weight of the Clamp & Hold Module. The weight of the Tapes extending
beyond the modules is neglected.

TABLE III
TAPE SIZE, SHAPE & COMPOSITION

Width: 2 in (nominal)
Shape: Straight section in the middle with outer sections curved in
a circular arc with 10° included angle and 5° contact angle at each end.
Thickness: 0.005 in
Height: 0.0486 in = 0.0436 in + 0.005 in (arch height + tape thickness)
Material: nickel covered spring steel. (Nickel coating prevents corrosion
and enhances friction hold during clamping.)
Tensile Strength: 300 lbf using 30 E3 psi as safe working strength for
steel.

TABLE IV
BLADDER SIZE, SHAPE & COMPOSITION

Size of Clamp Module Bladder: 2.1035 in long, 1.9375 in wide, 0.024 in max thickness in
middle, 0.048 max thickness at ends (0.020 in max liquid thickness in middle, 0.048 in
maximum liquid thickness in expanded end regions.)
Shape of Clamp Module Bladder: Bladder shape matches that of the Drive Electrodes on one
outer surface and of the Moveable Object (Tape or Pull & Return Electrode) on the surface
opposite, with a rectangular cross-section. Thickness is same along its width. Along its length,
thickness is more along the 2 end regions and less in the center. End regions expand away from
the Moveable Object with either bellows action (using bending) or stretch and return using
elasticity. End regions have bellows shape that spring returns liquid to center when electrostatic
force is reduced. Clamp Module Bladders and Drive & Return Module Bladders are flexible and
conformable. Purified water or purified water/glycol solution (for low temperature operations) is
hermetically sealed in the Bladder. The Bladders are in either an INTERNAL ELECTRODES
CONFIGURATION or a NO ELECTRODES CONFIGURATION.
The INTERNAL ELECTRODES CONFIGURATION uses wall materials of FEP (fluorocarbon)
film (a form of Teflon) which easily formed into bags, is structurally tough, is chemically inert to
water and most chemicals and is an electrical insulator with a low dielectric constant and high
electrical resistivity. Electro-less nickel electrodes are deposited on the inside of the Bladder
opposite each other and each of the inner electrodes is connected through the Bladder walls to an
electro-less nickel electrode on the outside of the Bladder walls to form a single conductor. High
phosphorous electro-less nickel is used because it is chemically inert and will resist degrading
the purified water or purified water/glycol solution. The outer surfaces of the outer electrodes are
covered by a thin, high dielectric constant, high resistivity insulator that functions as an isolation
capacitor. The FEP Bladder walls are typically 0.002 in thick to satisfy structural strength
requirements, but they can be made thicker if necessary with no effect on electrical performance.
The NO ELECTRODES CONFIGURATION uses wall material of Vespel SCP 5050 in wall
thicknesses of (say) 0.002 in. Vespel SCP 5050 has a high dielectric constant and high structural
strength and stiffness so the wall structure can act as both isolation capacitor and inner electrode
and can act as wall mechanical structural member at the same time. The electrical requirements
are best satisfied with thin walls and the mechanical requirements favor thicker walls with 0.002 in
wall thicknesses band the mechanical requirements favor thicker walls with 0.002 in wall
thicknesses being a reasonable compromise. It is also possible to make the walls thinner in the
electrically active areas and thicker in bellows regions to improve both electrical and mechanical
performance.
Size of Drive & Return Module Bladder:
: 2.1035 in long,
3 in wide (2.0 in + 0.5 in on each side)
0.036 in thick in middle (0.032 in liquid, 0.004 in bladder walls)
0.072 in thick on sides when extended (0.068 in liquid, 0.004 in bladder walls)

TABLE V
CLAMP MODULE

Length: 1.1625 in (length of 2 induction areas separated by 0.0625 in)
Width: 2.0625 in (1.9375 in induction area width + 0.0625 in wedge
contact structure on each side.)
Induction Electrode Area: 2.0625 in²(2 induction electrodes, each 1.9375
in wide × 0.55 in long, separated by 0.0625 in along length.)
Height: 1.411 in (n = 100 capacitors in each stack) (4 Tape Loops,
8 Tapes)
1.121 in (n = 50 capacitors in each stack) (4 Tape Loops, 8 Tapes)
(stack height + bladder thickness in middle + Tape Height + structure
separating Tape channels × number of channels (8).)
Weight: 0.9676 lb for n = 100 (1.1625 in × 2.0625 in × 1.411 in ×
0.286 lb/in³.)
0.7687 lb for n = 50 (1.1628 in × 2.0625 in × 1.121 in × 0.286 lb/in³)

TABLE VI
CLAMP & DRIVE MODULE

Length: 1.1625 in (length of 2 induction areas separated by 0.0625
in along length.)
Width: 2.5625 in (2.0625 in structure width + 0.25 in motion control
spring on each side.)
Clamp Induction Electrode Area: 2.0625 in²(2 induction electrodes, each
1.9375 in wide × 0.55 in long, separated by 0.0625 in along length.)
Drive Induction Electrode Area: :2.0625 in²(2 induction electrodes, each
1.9375 in wide × 0.55 in long, separated by 0.0625 in along length.)
Height: 1.783 in (n = 100 in each Clamp Tape Channel and n = 50 in
each of 2 Drive modules)
1.493 in (n = 50 in each Clamp Tape Channel and n = 50 in each of 2
Drive modules)
(Clamp & Drive Module height is Clamp Module height + Height of
each of 2 Drive Modules, where each Drive Module height = 0.186
in =: 0.0625 in (structure) + 0.0325 in stack (n = 50) + 0.032 in
(liquid) + 0.004 in (walls) + 0.010 (electrode) + 0.020 (wire EDM
clearance) + 0.005 (spring) + 0.020 Wire EDM (clearance))
Weight: 1.5191 lb (n = 100 in Clamp Module, n = 50 in each Drive
Module) (1.783 in × 2.5625 in ×
1.1625 in × 0.286 lb/in³ = 1.5191 lb) (height × width × length ×
density of steel)
1.2720 lb (n = 50 in Clamp Module, n = 50 in each Drive Module)
(1.493 lb + 2.5625 lb +
1.1625 lb × 0.286 lb/in³ = 1.2720 lb)) (height × width × length ×
density of steel)

### D. OVERALL SUMMARY AND CONCLUSIONS

A Tape Muscle concept is introduced as a viable, practical artificial muscle in which a bundle of thin, flexible tapes can perform muscle functions with each tape operating independent of the others such that hand and finger operations can be performed with strength, speed and dexterity. In most respects, Tape Muscle and human muscle capabilities are parallel and analogous. In some respects Tape Muscle is superior to human muscle. Tape Muscles do not tire. Tape Muscles do not bunch and cramp. The concept packages such that the tandem modules that power and direct the tapes are compact enough to fit on a human forearm. The concept can be scaled and extended to support arm and leg functions. The concept is all electric and does not require exotic materials. Rather, it innovates with known and proven concepts and technology.

The tape bundles would, typically, come in bundles of up to 4 tape loops, where each tape loop would actuate a single appendage to move it back and forth, analogous to a finger bending and straightening. The tapes would, typically, be 2 in. wide and 0.005 in thick and made of steel or some equivalent strength material. The Actuation Modules, through which the tapes are threaded, would, collectively, be on the order of 2.5 in. wide, 1.7 in. high (four tape loops) and 4.5 in. long. Each tape will pull with a force on the order of 100 lbf and will be capable of load-free movement of 6.5 in. per second. The total holding force available to each bundle of four tape loops would be on the order of 250 lbs. In applications where more tape loops are required, modules can be added, each with its own ability to supply force and power. The Tape Muscle would make possible a robotic hand operating with 16 tape loops (4 modules of 4 tape loops each) to execute and control independent back and forth finger motions of 16 finger or thumb appendages. The Actuation Modules would reside on an artificial forearm and occupy about 6 in wide by 1.7 in high by 4.5 in long. This seems well within the realm of possibility.

The Tape Muscle Actuation Modules each uses a tandem of a Clamp & Release module and Clamp & Pull module to grasp and pull a flexible tape in a series of step by step motions. The motions are small so bending flexures can execute them while operating with small, elastic bending angles. The steps are quick, so tape speed and reaction times are good. The tapes exert good force because small angle flexure bending provides mechanical advantage to both tape grasping and tape pulling. Tapes are deployed in tape loops because this enables flexible tapes to perform pull and push functions without fear of buckling and, at the same time, avoid the bunching associated with human muscles. It works out naturally because a load appendage, such as a finger, moves in one direction because of tensile force in one end of a tape loop. The appendage movement positions the tape loop for using tensile force in the other end for return movement of the appendage, so the appendage can be moved back and forth under tape tensile force. At the same time, clutter and bunching are avoided. Each tandem of modules has several channels, such that a single pair of modules can selectively move any single tape loop or combination of tape loops on command simply by individually clamping or releasing each tape end in the stationary module and selectively clamping or releasing each tape end in the drive module in synchronized combination. With this capability, movement direction is also an individual choice. This opens the possibility of operating the fingers of a hand from a very few sets of tandem modules that could easily package on a human forearm. The Tape Muscle concept can be scaled up or down to operate on fingers or arms, legs or shoulders. The concept can even be applied to skeletal muscle functions.

Multiple innovations are created to provide the concept competitive edge. First, the Charge-Driven Electrostatic Inductance innovation enables electrostatic force to be used in place of electromagnet force with no penalty in performance. In an unexpected consequence, the electric fields induced turned out strong enough to breakdown the air gaps short of inducing the required charge and force. So, a bladder, with a liquid dielectric sealed inside, is proposed to be placed in each tape channel to bring the induced electric field, charge and force in that channel up to required high performance standards without danger of electric breakdown. This enables individual tape channels to selectively clamp and release an individual tape with large force, even with the tapes and channels packed closely together. And this, in turn, enables tandems of modules to be packaged in the space of a human forearm sufficient to perform the functions of a human hand. The use of small bending angle flexures throughout also holds size down while providing large mechanical advantage in drive and clamping and release, thereby holding performance high and reducing size. These multiple detail innovations combine to change the nature, capability and usefulness of the artificial muscle concept.

### APPENDIX 1

### Development of Force Equation

The electrostatic forces are calculated throughout the system according to what we will call the STATIC FORCE METHOD. This method is particularly useful where forces are distributed across the liquid filled Bladder; where some of these forces hold the Tape against the Bladder, other forces hold the Drive Electrode against the Bladder and still other forces pull the Bladder walls together and force the Tape against the Wedge Contacts (in the case of Clamping) or pulls the Moveable Object to step the Tape forward or backward (in the case of the Drive Module). These forces must work cooperatively as a system and the STATIC FORCE METHOD illustrates the system nature of these forces well.

$$\begin{matrix}{C}_{2} = 2.0920190677591 \cdot {10}^{- 8} farads ( for a 2 {in}^{2} area ) 0.224808923655339 \\ Q \cdot \vec{E} = \vec{F} & eq ( 1 ) \\ {Q}_{0} = {V}_{S} ( {C}_{0} + {C}_{2} ) ( Charge trapped on Drive Electrode ) & eq ( 2 ) \\ {V}_{X} = \frac{{V}_{S} ( {C}_{0} + {C}_{2} )}{{C}_{X} + \frac{{C}_{2}}{n}} ( Equivalent voltage under load ) & eq ( 3 ) \\ {Q}_{X} = {V}_{X} {C}_{X} ( Charge across liquid gap X ) & eq ( 4 ) \\ {V}_{X} = {V}_{W} + {V}_{L} ( Voltage across capacitors in series ) & eq ( 5 ) \\ {V}_{L} = \frac{{Q}_{X}}{{C}_{L}} , \\ {V}_{W} = \frac{{Q}_{X}}{{C}_{W}} ( Voltage across each capacitor in a series ) & eq ( 6 ) \\ {\vec{E}}_{L} = \frac{{V}_{L}}{L} ( Electric field across liquid ) & eq ( 7 ) \\ \begin{matrix} {\vec{E}}_{W} = \frac{{V}_{W}}{W} ( both walls ) \\ = \frac{{V}_{W} / 2}{W / 2} ( one wall ) ( Electric field across walls )\end{matrix} & eq ( 8 ) \\ {\vec{F}}_{L} = {Q}_{X} {\vec{E}}_{L} ( force pulling Bladder walls together ) & eq ( 9 ) \\ {\vec{F}}_{W} = {Q}_{X} {\vec{E}}_{W} ( force holding Tape to one wall and Drive Electrode to other wall ) & eq ( 10 )\end{matrix}$$

### From eqs (2) and (3):

$${Q}_{0} = {V}_{S} ( {C}_{0} + {C}_{2} ) = {V}_{X} ( {C}_{X} + \frac{{C}_{2}}{n} ) \qquad eq ( 11 )$$

### Where:

$$\frac{1}{{C}_{0}} = \frac{1}{{C}_{W}} + \frac{1}{{C}_{L 0}} , \\ {C}_{0} = \frac{{C}_{W} \cdot {C}_{L 0}}{{C}_{W} + {C}_{L 0}} \qquad [ 20 ] eq ( 12 )$$

### And:

$$\frac{1}{{C}_{X}} = \frac{1}{{C}_{W}} + \frac{1}{{C}_{L}} , \\ {C}_{X} = \frac{{C}_{W} \cdot {C}_{L}}{{C}_{W} + {C}_{L}} \qquad [ 20 ] eq ( 13 )$$

### Recalling:

$${V}_{X} = \frac{{V}_{S} ( {C}_{0} + {C}_{2} )}{( {C}_{X} + \frac{{C}_{2}}{n} )} \qquad From eq ( 2 )$$

And eq (13), we calculate the charge on each of the capacitors in series between the Drive Electrode and the Tape.

$$\begin{matrix}\begin{matrix} {V}_{X} {C}_{X} = {Q}_{x} \\ = \frac{{V}_{S} ( {C}_{0} + {C}_{2} )}{( {C}_{X} + \frac{{C}_{2}}{n} )} \cdot \frac{{C}_{W} \cdot {C}_{L}}{{C}_{W} + {C}_{L}} \\ = {Q}_{W} \\ = {Q}_{L}\end{matrix} & eq ( 14 ) \\ {\vec{E}}_{L} = ( \frac{1}{L} ) \frac{{Q}_{X}}{{C}_{L}} ( across liquid dielectric ) , \\ {\vec{E}}_{W} = ( \frac{2}{W} ) \frac{{Q}_{X}}{2 {C}_{W}} ( across each wall ) & eq ( 15 ) \\ {\vec{E}}_{L} = ( \frac{1}{L} ) \cdot \frac{{V}_{S} ( {C}_{0} + {C}_{2} )}{( {C}_{X} + \frac{{C}_{2}}{n} )} \cdot \frac{{C}_{W}}{{C}_{W} + {C}_{L}} & eq ( 16 ) \\ {\vec{E}}_{W} = {\vec{E}}_{L} ( \frac{L}{W} ) ( \frac{{C}_{W}}{{C}_{L}} ) & eq ( 17 ) \\ {\vec{F}}_{L} = \frac{{V}_{S} ( {C}_{0} + {C}_{2} )}{( {C}_{X} + \frac{{C}_{2}}{n} )} \cdot \frac{{C}_{W} \cdot {C}_{L}}{{C}_{W} + {C}_{L}} \cdot ( \frac{1}{L} ) \cdot \frac{{V}_{S} ( {C}_{0} + {C}_{2} )}{( {C}_{X} + \frac{{C}_{2}}{n} )} \cdot \frac{{C}_{W}}{{C}_{W} + {C}_{L}} & eq ( 18 )\end{matrix}$$

Which simplifies to:

$${\vec{F}}_{L} = {V}_{S}^{2} \cdot ( \frac{1}{L} ) \cdot \frac{{( {C}_{0} + {C}_{2} )}^{2}}{( {C}_{X} + \frac{{C}_{2}}{n} )} \cdot \frac{{C}_{W}^{2} \cdot {C}_{L}}{{( {C}_{W} + {C}_{L} )}^{2}} \qquad eq ( 19 )$$

### And:

$${\vec{F}}_{W} = {\vec{F}}_{L} \cdot ( \frac{L}{W} ) \cdot ( \frac{{C}_{W}}{{C}_{L}} ) \qquad eq ( 20 )$$

To further simplify calculations, we reference all capacitances to C₂ the value of each capacitor in the Charge-Driven Electrostatic Induction system stack of identical capacitors. We choose n=50 as the number of capacitors in the stack.

$${C}_{L} = {K}_{L} \frac{{X}_{0}}{X} \cdot {C}_{2} \\ {C}_{L 0} = {K}_{L} \cdot {C}_{2} \\ {C}_{W} = {K}_{W} \cdot {C}_{2} ( 2 walls ) \\ 2 {C}_{W} = 2 {K}_{W} \cdot {C}_{2} ( 1 wall ) \qquad eq ( 21 )$$

Where X₀, K_{L}, and K_{W} are constants and where C_{L0}=C_{L} at X=X₀. This results in:

$${C}_{0} = \frac{{C}_{W} \cdot {C}_{L 0}}{{C}_{W} + {C}_{L 0}} = \frac{{K}_{W} \cdot {C}_{2} \cdot {K}_{L} \cdot {C}_{2}}{{K}_{W} \cdot {C}_{2} + {K}_{L} \cdot {C}_{2}} \\ {C}_{0} = \frac{{K}_{W} \cdot {K}_{L} \cdot {C}_{2}}{{K}_{W} + {K}_{L}} \qquad eq ( 22 )$$

### And:

$${C}_{X} = \frac{{C}_{W} \cdot {C}_{L}}{{C}_{W} + {C}_{L}} = \frac{{K}_{W} \cdot {C}_{2} \cdot {K}_{L} \cdot ( \frac{{X}_{0}}{X} ) \cdot {C}_{2}}{{K}_{W} \cdot {C}_{2} + {K}_{L} \cdot ( \frac{{X}_{0}}{X} ) \cdot {C}_{2}} \\ {C}_{X} = \frac{{K}_{W} \cdot {K}_{L} \cdot {X}_{0} \cdot {C}_{2}}{{K}_{W} \cdot X + {K}_{L} \cdot {X}_{0}} \qquad eq ( 23 )$$

Substituting eq (22) and eq (23) into eq (19) we find:

$$\begin{matrix}{\vec{F}}_{L} = {V}_{S}^{2} \cdot ( \frac{1}{L} ) \cdot \frac{{( \frac{{K}_{W} \cdot {K}_{L}}{{K}_{W} + {K}_{L}} + 1 )}^{2}}{{( \frac{{K}_{W} \cdot {K}_{L} \cdot {X}_{0}}{{K}_{W} \cdot X + {K}_{L} \cdot {X}_{0}} + \frac{1}{n} )}^{2}} \cdot \frac{{( {K}_{W} )}^{2} \cdot ( {K}_{L} \cdot \frac{{X}_{0}}{X} ) \cdot {C}_{2}}{{( {K}_{W} + {K}_{L} \cdot \frac{{X}_{0}}{X} )}^{2}} & eq ( 24 ) \\ L = X & eq ( 25 )\end{matrix}$$

### S0:

$${\vec{F}}_{L} = {V}_{S}^{2} \cdot {C}_{2} \cdot \frac{{( \frac{{K}_{W} \cdot {K}_{L}}{{K}_{W} + {K}_{L}} + 1 )}^{2}}{{( \frac{{K}_{W} \cdot {K}_{L} \cdot {X}_{0}}{{K}_{W} \cdot X + {K}_{L} \cdot {X}_{0}} + \frac{1}{n} )}^{2}} \cdot \frac{{( {K}_{W} )}^{2} \cdot ( {K}_{L} \cdot {X}_{0} )}{{( {K}_{W} \cdot X + {K}_{L} \cdot {X}_{0} )}^{2}} \cdot 39.37 \frac{in}{m} newtons \qquad eq ( 26 )$$

### And:

$${\vec{F}}_{W} = {\vec{F}}_{L} \cdot ( \frac{X}{W} ) \cdot ( \frac{{C}_{W}}{{C}_{L}} ) = ( \frac{X}{W} ) \cdot ( \frac{{K}_{W}}{{K}_{L} \cdot ( \frac{{X}_{0}}{X} )} ) \\ {\vec{F}}_{W} = {\vec{F}}_{L} \cdot ( \frac{X}{W} ) \cdot ( \frac{{K}_{W} \cdot X}{{K}_{L} \cdot {X}_{0}} ) \qquad eq ( 27 )$$

We describe a method for determining K_{L} and K_{W}, where the components are referenced to C₂ of the stack of nC₂ series capacitors as per:

$${C}_{L} = {K}_{L} \frac{{X}_{0}}{X} {C}_{2} \\ and \\ {C}_{W} = {K}_{W} {C}_{2} \qquad eq ( 3 )$$

### Where:

$$\frac{{C}_{L}}{{C}_{2}} ( at X = {X}_{0} ) = \frac{\frac{{ɛ}_{0} {ɛ}_{L} A}{{d}_{L}}}{\frac{{ɛ}_{0} {ɛ}_{2} A}{{d}_{2}}} = \frac{{ɛ}_{L} {d}_{2}}{{ɛ}_{2} {d}_{L}} = {K}_{L} = \frac{{ɛ}_{L} {d}_{2}}{{ɛ}_{2} {X}_{0}} \qquad eq ( 4 )$$

We know ∈_{L} for purified water (or distilled water) is approximately 80 at 25 deg C. [12] and we know d_{L}=X₀ because we set this as an operational requirement for the thickness of the liquid dielectric filled Gap between the Bladder walls. Also we know ∈₂ and d₂ for C₂ from product literature for 3-M C1011 embedded capacitor materials. With this information we can calculate K_{L}. Also, we can calculate a capacitor using 3-M C1011 for any area where we calculate C₂=2.0920190677591·10⁻⁸ farads (for a 2 in² area).
Similarly for a wall material of choice we have:

$$\frac{{C}_{W}}{{C}_{2}} = \frac{\frac{{ɛ}_{0} {ɛ}_{W} A}{{d}_{W}}}{\frac{{ɛ}_{0} {ɛ}_{2} A}{{d}_{2}}} = \frac{{ɛ}_{W} {d}_{2}}{{ɛ}_{2} {d}_{W}} = {K}_{W} \qquad eq ( 5 )$$

Where ∈_{W} is given in product literature and d_{W} is a design choice. As stated above, ∈₂ and d₂ for 3-M C1011 [ref] are given in product literature. We currently envision using 3-M C1011 for both the Drive Electrode attack of n C₂ capacitors and for the C_{W} isolation capacitors in INTERNAL ELECTRODE CONFIGURATIONS and Vespel SCP 5050 is envisioned for NO ELECTRODE CONFIGURATIONS. Vespel SCP product literature [17] provides ∈_{W}=20 and d_{W} is a design choice where mechanical strength of the Bladder walls must be balanced against the need to keep Bladder walls thin and their capacitance high to maximize electrostatic forces.

Eq (26) tells us the electrostatic force across the liquid dielectric. This is the force that pulls the Bladder walls towards each other and that pulls the Tape along with the Bladder walls. The force with which the Tape is pulled is the force that is applied to the Clamping or Drive operations as the case may be.

Eq (27) tells us the electrostatic force that holds the Tape to the Bladder and holds the Bladder to the Drive Electrode and to the structure the Drive Electrode is attached to. Without the eq (27) forces, the Bladder walls could, conceivably, come together while leaving the Tape behind.

Equations (4) and (5) tell us how to calculate K_{L}, and K_{W} en route to solving eq (26) and eq (27).

The Charge-Driven voltage across the Gap between Drive Electrode and Tape is divided between voltage across the liquid insulation dielectric, voltage across the insulator isolating the liquid from the Drive Electrode and voltage across the insulator isolating the liquid from the Tape. The voltage across the insulator isolating liquid dielectric from Tape also provides the force that holds the Tape to the Bladder. The voltage across the insulator isolating liquid dielectric from Drive Electrode also provides the force that holds the Bladder to the Drive Electrode and to its support structure. All three forces are needed to move the Tape with force and the forces that hold the Tape and Drive Electrode to the Bladder must be equal to or greater than the force pulling the Bladder walls together. When INTERNAL ELECTRODE CONFIGURATION is used, the isolation insulators are thin coverings over the outer portions of the internal/external pairs and are not required to perform Bladder wall mechanical functions, with the exception of providing a surface over which the Tape can slide under no load conditions. This means, the isolation insulators can be selected for optimal electrical performance with minimal compromises for mechanical duties. They can be made very thin because the Bladder walls are not dependent on their mechanical strength and they can be made of ceramic because the Bladder walls need not bend at their location. The insulator ceramic is anchored to a mechanically strong and tough conductor, typically electro-less nickel so it supported against flaking off when the Tape slides over it, especially under no load conditions. When NO ELECTRODE CONFIGURATION is used the Bladder walls perform both the isolation insulator and Bladder wall mechanical functions. This means its electrical performance is compromised to permit its proper mechanical function. For example, it must be made thick enough to provide adequate Bladder mechanical strength and this reduces it performance as an isolation capacitor.

The equations developed apply to both cases though the values for K_{w} will depending on material chosen and wall thickness required

### APPENDIX 2

### Refresh Rate Determination

C₂=2.0920190677591·10⁻⁸ farads (for a 2 in² area) 0.224808923655339

Charge stored in the system will leak off all the conductors back through dielectric insulators so the system requires periodic recharging to compensate. Charge leakage in one part of the system affects the rest of the system and charge leakage is going on simultaneously in all components. The rate of leakage for each component is the inverse of its time constant and the leakage rate of the system is per eq (1). The refresh rate must exceed the leakage rate.

$${f}_{Ref} \geq \frac{1}{{τ}_{Sys}} = \frac{1}{{τ}_{Gap}} + \frac{1}{{τ}_{Stk}} \\ Where \text{:} \\ {τ}_{Gap} = {R}_{Gap} {C}_{Gap} \\ and \\ {τ}_{Stk} = {R}_{Stk} {C}_{Stk} \qquad eq ( 1 )$$

We now determine the capacitance and resistance of each component. We start with the capacitances of each.

$$\frac{1}{{C}_{Gap}} = \frac{1}{{C}_{L}} + \frac{1}{{C}_{W}} \\ Where \text{:} \\ {C}_{Gap} = \frac{{C}_{L} {C}_{W}}{{C}_{L} + {C}_{W}} \\ {C}_{Stk} = \frac{{C}_{2}}{n} \qquad eq ( 2 )$$

Where components are referenced to C₂ of the stack of nC₂ series capacitors as per:

$$\begin{matrix}{C}_{L} = {K}_{L} \frac{{X}_{0}}{X} {C}_{2} , \\ {C}_{W} = {K}_{W} {C}_{2} \\ ( {K}_{L} and {K}_{W} are constants ) and {C}_{Stk} = \frac{{C}_{2}}{n} & eq ( 3 ) \\ {C}_{Gap} = \frac{{C}_{L} {C}_{W}}{{C}_{L} + {C}_{W}} = \frac{{K}_{L} \frac{{X}_{0}}{X} {K}_{W}}{{K}_{L} \frac{{X}_{0}}{X} + {K}_{W}} {C}_{2} = \frac{{K}_{L} {X}_{0} {K}_{W}}{{K}_{L} {X}_{0} + {K}_{W} X} {C}_{2} & eq ( 4 )\end{matrix}$$

### Where:

$$\frac{{C}_{L}}{{C}_{2}} ( at X = {X}_{0} ) = \frac{\frac{{ɛ}_{0} {ɛ}_{L} A}{{d}_{L}}}{\frac{{ɛ}_{0} {ɛ}_{2} A}{{d}_{2}}} = \frac{{ɛ}_{L} {d}_{2}}{{ɛ}_{2} {d}_{L}} = {K}_{L} = \frac{{ɛ}_{L} {d}_{2}}{{ɛ}_{2} {X}_{0}} \qquad eq ( 5 )$$

### And:

$$\frac{{C}_{W}}{{C}_{2}} = \frac{\frac{{ɛ}_{0} {ɛ}_{W} A}{{d}_{W}}}{\frac{{ɛ}_{0} {ɛ}_{2} A}{{d}_{W}}} = \frac{{ɛ}_{W} {d}_{2}}{{ɛ}_{2} {d}_{L}} = {K}_{W} \qquad eq ( 6 )$$

We choose 3-M C1011 embedded capacitor material [9] for C₂ and calculate C₂=2.0920190677591·10⁻⁸ farads (for a 2 in² area). We now have the equations needed to calculate the capacitances of each of the Bladder system components and we can turn our attention to determining the resistance of each component.
Capacitors have a resistive component whereby charge on the electrodes can leak back through the dielectric, which requires periodic refreshment to restore and maintain the charge.

R_{Gap}=R_{L}+R_{W} R_{Stk}=nR_{C2} eq (7)

This resistance is as per:

$$ρ = R \frac{A}{L} or R = ρ \frac{L}{A} [ 19 ] \qquad eq ( 8 )$$

### Where:

ρ=Volume resistivity of material (in ohm−m or ohm−in)
R=Resistance of component in ohms.
A=Cross-section area of component resistor
L=Length of the component resistor

A dielectric insulating material is typically specified with a resistivity p so the rate of leakage and the losses in alternating current applications can be determined. With the resistivity value, the resistance of a particular component using the material can be calculated according to eq (6). We have focused on three materials for our dielectric insulator needs. We have chosen 3-M C1011 [9] for applications where high performance is most important and where the material need not bend and sustain tensile stress and strain. Vespel SCP 5050 has been chosen for applications where the material must perform both mechanical and electric functions and where the combined mechanical and electrical performance is most important. Purified or distilled water has been chosen where the electrical insulating dielectric must move and deform to allow electrostatic work to be performed. Product literature gives resistivity values for Vespel SCP 5050 [17] and open literature [13] gives resistivity values for purified or distilled water.

ρ_{Vesp}=3.7·10⁷ ohm−in [17] eq (9)

ρ_{water}=182,000 ohm−m=7165340 ohm−in at 25 deg C. [13] eq (10)

ρ_{C1011}=2.32558139534·10¹¹ ohm−in eq (11)

[From product literature for 3-M C1011 and as per discussion below.]
Product literature for 3-M C1011 gives
100·10⁶ ohms resistance given for 3-M C1011 at a thickness of 0.00043 in [9]

From this information the reader is left to determine the resistivity of 3-M C1011 and from there the resistance of a particular 3-M C1011 component. So, we return to the resistivity equation and work it in reverse to first determine resistivity of C-1011 and then resistance of C₂.

$$ρ = R \frac{A}{L} [ ref ] \\ {ρ}_{C 1011} = 100 \cdot {10}^{6} ohms \cdot \frac{A}{0.00043 in} \qquad eq ( 12 )$$

We calculate ρ_{C1011} based on A=1 in² giving us ρ_{C1011}=2.32558139534·10¹¹ ohm-in. We then determine the electrical resistance of a particular area of C1011 using the relationship

$$ρ \cdot \frac{L}{A} = R ohms = 2.32558139534 \cdot {10}^{11} ohm - in \cdot \frac{0.00043 in}{A {in}^{2}} ( for C 1011 ) \qquad eq ( 13 )$$

We now have resistivity values for each of our preferred materials and are able to calculate resistance value for each of the Bladder components.

ρ_{C1011}=2.32558139534·10¹¹ ohm−in

ρ_{water}=182,000 ohm−m=7165340 ohm−in at 25 deg C. [13]

ρ_{Vesp}=3.7·10⁷ ohm−in [17]

Which leads to:

$${R}_{Gap} = {ρ}_{C 1011} \frac{{W}_{C 1011}}{A} + {ρ}_{water} \frac{X}{{X}_{0} A} ( INTERNAL ELECTRODES CONFIGURATION ) \qquad eq ( 14 )$$

### Or:

$${R}_{Gap} = {ρ}_{Vespel} \frac{{W}_{Vespel}}{A} + {ρ}_{water} \frac{{X}_{0}}{XA} ( NO ELECTRODES CONFIGURATION ) \qquad eq ( 15 )$$

### And:

$${τ}_{Gap} = {R}_{Gap} {C}_{Gap} \\ and \\ {τ}_{Stk} = {nR}_{C 2} \frac{{C}_{2}}{n} = {R}_{C 2} {C}_{2} \qquad eq ( 16 )$$

### And:

$${f}_{Ref} \geq \frac{1}{{τ}_{Sys}} = \frac{1}{{τ}_{Gap}} + \frac{1}{{τ}_{Stk}} ( From ) \qquad eq ( 1 )$$

### End of Appendix 2

### REFERENCES

[1] Vranish, J. M., Linear Tape Motor, U.S. Pat. No. 7,989,992B2 Aug. 2, 2011
[2] Vranish, J. M., Charge-Driven Electrostatic Inductance, patent application filed Oct. 18, 2011, U.S. PTO Ser. No. 13/317,373.
[3] p. 598, Mechanics of Materials, Ferdinand P. Beer, E. Russell Johnston, Jr, Copyright 1981, 1979, ISBN: 0-07-004284-5, McGraw-Hill, Inc.[Bending Equations for a cantilever beam]
[4] Search: [Friction of Materials], Click On: [the engineering toolbox], Find: [nickel on nickel]. [Friction coefficients]
[5] p. 38, Beer [Young's modulus & Hook's Law defined]
[6] p. 634, Physics for Scientists & Engineers with Modern Physics Third Edition, Raymond A. Serway, Copyright 1990, 1986, 1982, Library of Congress Catalog Card Number, 89-043326, SAUNDERS GOLDEN SUNBURST SERIES, Saunders College Publishing. [definition of electrostatic force in terms of charge and field]
[7] p. 717, Serway [definition of capacitance in terms of charge and voltage]
[8] pp. 721, 722, Serway [definition of electric field in terms of voltage and electrode separation]
[9] Search [3M ECM], Click On [3M Singapore Embedded Capacitance Material What is 3M ECM?], Click On [3M Embedded Capacitance Material Properties], Find,[c1011 (preliminary)]
[10] Search, [Breakdown Voltage of Air], Click On [Electrical breakdown—Wikipedia, the free encyclopedia], Click On [References 1. Hong, Alice (2000) “Dielectric Strength of Air” The Physics Factbook]
[11] Search, [Dielectric Strength], Click On [Dielectric strength-Wikipedia, the free encyclopedia], Find, [Dielectric Strength of Distilled Water]
[12] Search, [Relative Permittivity], Click On, [Relative permittivity, Wikipedia—the free encyclopedia], Find [Water]
[13] Search [Properties of Water], Click On, [Properties of water, Wikipedia the free encyclopedia], Find [Electrical properties-Electrical conductivity].
[14] Pulsed high-voltage dielectric properties of ethylene glycol/water mixtures, David B. Fenneman, Naval Surface Weapons Center Dahlgren, Va., 2 2448, published in 8961 J. Applied Phys. 53(12), December 1982.
[15] FEP Flurocarbon Film Properties Bulletin H550083 (August, 2010) from Dupont Corp.
[16] Search, [Electro-less nickel plating], Click On, [Electroless nickel plating, Wikipedia the free encyclopedia], Find [Types-low phosphorous electro-less nickel, medium phosphorous electro-less nickel, high phosphorous electro-less nickel].
[17] Dupont Vespel SCP5050 Polyimide Direct-Formed Parts, (May, 2009) Reference No. VPE-A10988-00-AD711.
[18] Properties of DuPont VESPEL Parts (August 1993) 233630A
[19] Search, [electrical resistivity], Click On, [Electrical resistivity and conductivity, Wikipedia the free encyclopedia], Find [equations and definition of terms for resistivity and conductivity].
[20] pp. 716, 717, Serway [Capacitors in series]
   *Note: All search instructions verified by author as of Dec. 2, 2011.

Having thus shown and described what is at present considered to be the preferred embodiment of the invention, it should be noted that the same has been made by way of illustration and not limitation. Accordingly, all modifications, alterations and changes coming from within the spirit and scope of the invention as set forth in the appended claims are herein to be included.

What is claimed is:

1. A system for moving and positioning each of one or more objects simultaneously and independently of the others comprising:
one or more Mobile apparatuses, each of which can independently be moved and do work on an external object in a chosen direction by means of energy and force applied to it by an external energizing means;
a Clamp & Drive apparatus, that guides, moves and performs work on each said mobile apparatus, independent of other said mobile apparatuses;
a fixed Clamp apparatus, which guides, clamps and releases each said mobile apparatus, independent of other said mobile apparatuses, in coordination and synchronization with said Clamp & Drive apparatus;
ameans for coordinating and synchronizing actions of said Clamp apparatus and said Clamp & Drive apparatus, whereby each said Mobile apparatus can be independently moved in either of two directions, whereby each said Mobile apparatus can be independently moved at varying speeds of choice, whereby each said Mobile apparatus can be independently positioned;
a means of supplying and controlling power to said Mobile apparatuses;
a means for said Mobile apparatuses to remain in place with respect to said stationary Clamp apparatus with external power off and oppose external forces on said Mobile apparatuses and said attached Objects (payloads);
a means for said Mobile apparatuses and said attached Objects (payloads) to be independently and precisely positioned, over relatively long stroke distances;
a means for said Mobile apparatuses to be independently moved and do work on said objects over long stroke distances without interference and within a fixed work volume;
said Mobile apparatuses, wherein each said Mobile apparatus flexible structure is elastically bent in a loop with the open ends threaded through a passage in said Clamp & Drive apparatus and threaded through a passage in said Clamp apparatus, wherein each said flexible structure bends so as to clamp with mechanical advantage and recovers from bending so as to release with mechanical advantage, wherein each open end of a said mobile apparatus flexible structure is attached to a shared object, whereby said shared object moves in either of two directions with the movement of said open ends, whereby location of each loop turn-around does not change, wherein each said Mobile apparatus flexible structure is bent in a loop outside the loop of each said preceding Mobile apparatus flexible structure, whereby each said Mobile apparatus flexible structure and Object attached thereto can move back and forth without interfering with other said Mobile apparatuses flexible structures and Objects attached thereto;
said Clamp apparatus, wherein a separate passage is provided for each said Mobile apparatus flexible structure open end, wherein an independent Clamp & Release means is provided in each said separate passage, whereby each said mobile apparatus flexible structure open end can be independently clamped to mechanical ground or released from mechanical ground on command, wherein said clamp or release can be sustained;
said Clamp & Drive apparatus, wherein a separate passage is provided for each said Mobile apparatus flexible structure open end, wherein an independent Clamp & Release means is provided in each said separate passage, whereby each said Mobile apparatus open end flexible structure can be independently clamped to or released from said Clamp & Drive apparatus on command, wherein a Drive & Return means is provided to move said Clamp & Drive apparatus in back and forth motion and to move and do work on said Mobile apparatus flexible structure open ends clamped thereto, whereby each said Mobile apparatus flexible member open end can be independently moved in a single, chosen direction;
said Drive & Return means, wherein a Pull & Return flexible structure is elastically bent with small angle bending in response to external forces, whereby said Clamp & Drive apparatus and said Mobile apparatus open ends clamped thereto, move in direction of travel with mechanical advantage, wherein said external forces can be removed, whereby said Pull & Return flexible structure straightens with mechanical advantaged spring return, wherein said motion control flexures constrain Drive Return movement to said direction of travel, whereby said Clamp & Drive apparatus returns to its original position along said direction of travel, whereby said Mobile apparatus flexible structure open ends attached thereto are returned as well, whereby said Clamp & Drive apparatus moves past said unclamped mobile apparatus flexible structures, wherein said Drive & Return means can hold said Clamp & Drive apparatus in position, wherein said Clamp & Release means can maintain Clamp or Release of said Mobile apparatus flexible structures.

2. A system according to claim 1, whereby a single mobile apparatus can move an object in either of two chosen directions, independent of other mobile apparatuses as the result of coordinated, synchronized actions by said Clamp and Clamp & Drive apparatuses, using a series of grasp, pull, release and return actions.

3. A system according to claim 2, whereby a single mobile apparatus can move an object in either of two chosen directions, using tension forces in said mobile apparatus.

4. A system according to claim 2, whereby each of several said multiple mobile apparatuses can move a said object attached thereto, simultaneously and independent of other said multiple apparatuses and said multiple objects as the result of coordinated, synchronized actions by said Clamp and Clamp & Drive apparatuses, using a series of grasp, pull, release and return actions.

5. A system according to claim 4, whereby said mobile apparatuses can simultaneously move, do work on and apply force to said multiple objects attached thereto using tension forces in each of said mobile apparatuses.

6. A system according to claim 1, wherein each said mobile apparatus flexible structure is flexible about an axis in the direction of travel, flexible about the axis in the direction of width, stiff about the axis in the direction of thickness and is stiff in the direction of travel.

7. A system according to claim 6, wherein each said mobile apparatus flexible structure, is curved near the edges whereby said edges and edge contact surfaces are angled with respect to toe said axis in the said direction of width.

8. A system according to claim 7, wherein each said passage in said Clamp and Clamp & Drive apparatus, has angled contact surfaces, whereby said flexible structure angled edge contact surfaces and said passage angled contact surfaces make normal contact with each other.

9. A system according to claim 8, wherein said contact angles of said passages are small with respect to the axis in the direction of said flexible structure thickness and the contact angles of said flexible structure are small with respect to the axis in the direction of said flexible member width, whereby said Clamp and Clamp & Drive contacts are made with large mechanical advantage.

10. A system, according to claim 9, wherein said flexible structures bend after forced contact with said angled contact surfaces in said passages, wherein, said bending is limited to small angles, whereby contact normal force between said flexible structures and said angled contact surfaces increases without sliding.

11. A system, according to claim 10, wherein said flexible structures, bent after said forced contact with said angled contact surfaces in said passages, unbends after removal of said forced contact action, whereby said contact normal forces between said flexible structures and said angled contact surfaces in said passages, are removed with mechanical advantage.

12. A Clamp & Drive apparatus, according to claim 1, wherein said Drive & Return means is accomplished by means of bending and relaxing a Drive & Return flexible structure therein, whereby said Clamp & Drive apparatus moves in said direction of travel, with mechanical advantage.

13. A Drive & Return system, according to claim 12, wherein said Drive & Return flexible member structure bending is accomplished by applying an external force to said flexible member structure in a direction normal to said direction of travel, wherein said external force is applied to each said Drive & Return flexible member through a relatively stiff electrode structure, connected to said Drive & Return flexible member at its center of bending, wherein said flexible member structure unbending is accomplished by removing said external force, wherein said flexible member structure bending is limited to small bending angles, whereby drive force is exerted in said direction of travel with mechanical advantage during both bending and unbending, whereby step size is reduced, wherein step rate is increased, whereby travel speed is accomplished.

14. A system, according to claim 13, wherein said flexible member structure is thin along one axis orthogonal to said direction of travel, wide along a second axis orthogonal to said direction of travel and long along said axis of travel, wherein said external force is applied in direction of said axis measuring the thickness of said flexible member structure, whereby said flexible member structure bends easily when said external force is applied and remains stiff in said direction of travel, whereby said Clamp & Drive apparatus can apply large, stiff forces to said mobile apparatuses in each of two directions along said direction of travel.

15. A system according to claim 14, wherein said Clamp & Drive apparatus contains a Drive & Return means, wherein said Drive & Return means comprises a Drive & Return apparatus located at the top and a Drive & Return apparatus located at the bottom of said Clamp & Drive apparatus, wherein, top and bottom are measured along said flexible member structure axis of thickness, wherein said Drive & Return apparatuses are mirror images of each other, whereby said Drive & Return forces applied to said mobile apparatuses are the sum of forces from the two said Drive & Return apparatuses, wherein said Drive & Return apparatuses are connected to the said Clamp & Release portion of said Clamp & Drive apparatus by motion control flexures, whereby said Clamp & Release apparatus is constrained to travel back and forth along said axis of travel.

16. A system according to claim 15, wherein each said Motion Control Flexure structure is thin in the direction of travel, long in said top to bottom direction of said Clamp & Drive apparatus and is wide in the remaining orthogonal direction, whereby each said motion control flexure bends easily in said direction of travel and is stiff in other orthogonal directions, wherein, said motion control flexures are deployed in identical mirror image sets whereby errors in the direction of travel are balanced, wherein bending is elastic and small bending angles are used, whereby said motion control flexures stretch to accommodate travel with high mechanical advantage and minimal force losses.

17. A system according to claim 16, wherein said means for supplying and controlling power to clamp said Mobile apparatus flexible structures to said Clamp & Release angled contact surfaces and to release said Mobile apparatus flexible structures from said Clamp & Release angled contact surfaces uses electrostatic induction, wherein said electrostatic induction power can be independently applied in each said passage, wherein an electrode system in each said passage can independently acquire electric potential, whereby electric charge is induced on said Mobile apparatus flexible structure therein and equal opposite charge is induced on said electrode system, whereby electrostatic attractive force is generated between said mobile apparatus flexible structure and said electrode system, whereby said mobile apparatus flexible structure is independently clamped to said passage structure, wherein each said electrode system can independently remove an electric potential, whereby said electrostatic attractive force is removed, whereby said mobile apparatus flexible structure is independently released from clamping in said passage, wherein frequency of said Clamp & Release electrostatic induction system is sufficient to provide high speed clamp and release sufficient to support sufficient travel speed of said Mobile apparatuses, wherein each said passage electrode system can independently retain trapped charge, whereby each said mobile apparatus flexible structure therein can remain clamped, wherein each passage electrode system, wherein each said passage electrode system can independently power off with zero potential, whereby each said mobile apparatus flexible structure therein remains free from clamping while said power is off.

18. A system according to claim 16, wherein said means for supplying and controlling power to each said Drive & Return means uses electro-static induction, wherein each said electrode system can independently acquire electric potential, whereby electric charge is induced on each said Drive & Return flexible member electrode and equal and opposite charge is induced on said electrode system therein, whereby electrostatic attractive force is generated between each said electrode system and said Drive & Return flexible member electrode, whereby each said Drive & Return flexible member is pulled towards its corresponding electrode system therein, whereby each said Drive & Return flexible member structure bends at its center of bending, whereby said Clamp & Drive apparatus is pulled a distance in said direction of travel, wherein said bending is with small angles, whereby said movement in said direction of travel is with mechanical advantage, wherein each said electrode system can independently an electric potential of zero, whereby zero electric charge is induced on each said flexible member electrode, therein whereby electrostatic force between each said electrode system and said Drive & Return flexible member electrode is set to zero, whereby a previously bent said Drive & Return flexible member structure returns said Clamp & Drive apparatus to its rest position in said direction of travel, with small angle mechanical advantage, using energy stored during bending, said electrode system, wherein frequency response is sufficiently high to provide sufficient travel speed for said Mobile apparatuses and said Objects attached thereto, wherein each said electrode system can retain charge, whereby said Drive & Return means can hold maximum travel position with power off, wherein each said electrode system can retain zero charge with power off, whereby said Drive & Return means can hold return, minimum travel position.

19. A system, according to claim 17, wherein said electrostatic induction system used to independently Clamp & Release said Mobile apparatuses and to independently hold or release clamp in said Mobile apparatuses is performed by means of Charge-Driven Electrostatic Induction [2].

20. A system, according to claim 18, wherein said electro-static induction system used to Drive & Return said Clamp & Drive apparatus and to hold said Clamp & Drive apparatus at maximum travel position with power off or to release said Clamp & Drive apparatus at minimum travel position is performed by means of Charge-Driven Electro-static Inductance [2].

21. An enhanced performance electro-static induction system whereby, a drive electrode system can induce enhanced electric charge on and do work on a remote electrical conductor system, separated from said drive electrode system by a large, deformable insulation gap with high permittivity and high dielectric strength, comprising:
a drive electrode system, wherein a voltage can be generated on said drive electrode, whereby enhanced performance electro-static induction system can be energized, wherein said drive electrode system recharge and refresh system re-energizes and recharges said drive electrode system to redress charge leak, wherein said drive electrode system can be constructed and operated according to said Charge-Driven Electro-static Induction [2].
a large, deformable insulation gap with high permittivity and high dielectric strength, wherein a bladder is filled with a fluid electrical insulator that has high electrical resistivity, high permittivity and high dielectric strength, wherein said bladder can deform and said fluid can move to reduce said insulation gap, in response to said external force on said remote electrical conductor and, wherein said bladder and said fluid will return to original conditions upon removal of said electrode and said remote electrical conductor.
a remote electrical conductor system, wherein said system can move in response to an external electric field to reduce said insulation gap distance and can return to said original position and said original insulation gap distance when said external electric field is removed, wherein said system functions, throughout, as part of the electrical circuit coupling said drive electrode system, said large, deformable insulation gap and electrical ground.

22. A deformable, thin-walled, electrical insulator bladder structure, according to claim 21, with electrically conductive electrode structures attached thereon, wherein each said electrode structure has a component inside said bladder walls and a component outside a said bladder wall, wherein said components outside said bladder walls and said components inside said bladder walls are connected in pairs by an electrically conductive structure for each pair that passes through said bladder walls, wherein passage of fluids through said bladder walls is opposed, whereas electrical current and charge passes easily from one side of said walls to the other, wherein said electrode pairs are on opposite sides of said bladder structure, wherein said outer electrodes are each externally covered by thin electrical insulator with a high dielectric constant, high resistivity, high dielectric strength, high mechanical toughness and low friction and wear.

23. A bladder system according to claim 22, wherein one said outer electrode is in contact with a said drive electrode and the opposite said outer electrode is in contact with a said Moveable Object, wherein said contacts are maintained throughout the full range of bladder system deformation, wherein voltage drop between said drive electrode and said Moveable Object is distributed between voltage drops across two said thin electrical insulators and the voltage drop across the said liquid dielectric insulator filling said bladder, whereby said bladder walls are electrically bypassed, whereby said bladder wall materials and thickness can be optimized for mechanical performance and resisting chemical interactions with said liquid insulator dielectric, whereby said inner electrodes can be optimized for high electrical conductivity and for resisting chemical interactions with said liquid insulator, whereby said thin electric insulators covering said outer electrodes can be optimized for high permittivity, high resistivity, low thickness, hig dielectric strength, high mechanical toughness and low friction and wear.

24. A system according to claim 21, wherein said fluid with high electrical resistivity, high permittivity and high dielectric strength fluid is a liquid.

25. A system, according to claim 21, wherein said bladder deforms by means of elastic stretching.

26. A system, according to claim 21, wherein said bladder deforms by means of elastic bending in a bellows structure therein.

27. A system, according to claim 21, wherein said liquid is distilled water, purified water or deionized water.

28. A system, according to claim 26, wherein said bladder is constructed to be chemically resistant to distilled or purified water.

29. A system, according to claim 21, wherein said liquid is a purified water/purified ethylene glycol solution.

30. A system, according to claim 28, wherein said bladder is constructed to be chemically resistive to a said purified water/purified ethylene glycol solution.

31. A system according to claim 19, wherein said Clamp & Release electrostatic induction system uses a said Enhanced Performance Electro-static Induction system.

32. A system according to claim 20, wherein said Drive & Return electrostatic induction system uses a said Enhanced Performance Electro-static Induction system.
